(19) United States
(12) Patent Application Publication
(10) Pub. No.: US 2026/0342619 A1
(43) Pub. Date: Oct. 29, 2026

(54) DM-RS FREE OPERATION IN WIRELESS SYSTEMS

(71) Applicant: InterDigital Patent Holdings, Inc., Wilmington, DE (US)

(72) Inventors: Mohamed Salah Ibrahim, Chesterbrook, PA (US); Omar Sleem, State College, PA (US); Akshay Malhotra, San Jose, CA (US); Philip Pietraski, Jericho, NY (US); Mihaela Beluri, Jericho, NY (US)

(73) Assignee: InterDigital Patent Holdings, Inc., Wilmington, DE (US)

(21) Appl. No.: 19/110,153

(22) PCT Filed: Sep. 7, 2023
(86) PCT No.: PCT/US2023/032179

§ 371 Date: Mar. 10, 2025

Related U.S. Application Data
(60) Provisional application No. 63/405,021, filed on Sep. 9, 2022.

(51) Int. Cl. H04L 25/02; H04L 1/00; H04W 24/10

(52) U.S. Cl. CPC H04L 25/0214; H04L 1/0047; H04W 24/10

(57) ABSTRACT

Systems, methods, and instrumentalities are described herein for demodulation reference signal (DM-RS) free operation in wireless systems. A data channel structure (e.g., DM-RS free data channel structure) may be used. The DM-RS free data channel structure may enable unsupervised DM-RS free equalization. The DM-RS free data channel structure may enable reporting performance indicators and parameters associated with the DM-RS free data channel structure.

### CROSS-REFERENCE TO RELATED APPLICATIONS

This application claims the benefit of Provisional U.S. Patent Application No. 63/405,021, filed Sep. 9, 2022, the disclosure of which is incorporated herein by reference in its entirety.

### BACKGROUND

Mobile communications using wireless communication continue to evolve. A fifth generation may be referred to as 5G. A previous (legacy) generation of mobile communication may be, for example, fourth generation (4G) long term evolution (LTE).

### SUMMARY

Systems, methods, and instrumentalities are described herein for demodulation reference signal (DM-RS) free operation in wireless systems. A data channel structure (e.g., DM-RS free data channel structure) may be used. The DM-RS free data channel structure may enable unsupervised DM-RS free equalization. The DM-RS free data channel structure may enable reporting performance indicators and parameters associated with the DM-RS free data channel structure.

A WTRU may perform canonical correlation analysis (CCA) (e.g., associated with a DM-RS free data channel structure). The WTRU may receive configuration information (e.g., CCA configuration information). The configuration information may indicate CCA view parameter(s) and/or CCA view(s). The CCA view parameter(s) may include one or more of the following: a location of a repeated resource element, a CCA view length, a start symbol, a resource block offset, a mapping order, a CCA reference signal configuration, and/or the like. The WTRU may determine CCA view(s), for example, based on the configuration information. A CCA view may include a group of REs. For example, the first CCA view may have a first group of REs and the second CCA view may have a second group of REs (e.g., where the second group of REs may be a copy of the first group of REs). A CCA view may be associated with a CCA view length, where the CCA view length may be associated with a repetition pattern density. The WTRU may determine (e.g., based on the configuration information) a first CCA view and a second CCA view. The WTRU may measure a CCA correlation coefficient associated with the first CCA view and the second CCA view. The WTRU may determine CCA sub-grid information (e.g., sub-grid size, number of sub-grids, and/or number of CCA reference signals (CCA-RSs) (e.g., per sub-grid)), for example, based on the first CCA view, the second CCA view, and the CCA correlation coefficient. A determined sub-grid size may be a number of resource blocks (RBs). The WTRU may determine whether to send an indication of the determined sub-grid size based on whether the determined sub-grid size is equal to a configured sub-band size. The WTRU may send a report (e.g., to the network) based on the determination of whether to send the indication of the sub-grid size. The report may indicate the determined number of CCA-RSs and the CCA correlation coefficient. The WTRU may demodulate and equalize the data channel, for example, with a received CCA-RS, the first CCA view, and the second CCA view.

The WTRU may determine that the determined sub-grid size does not equal the configured sub-band size. Based on the determination that the determined sub-grid size does not equal the configured sub-band size, the report may indicate the determined sub-grid size.

The WTRU may receive a channel state information reference signal (CSI-RS). The WTRU may perform a measurement based on the CSI-RS. The determination of the CCA sub-grid information may be performed, for example, based on the performed measurement based on the CSI-RS.

### BRIEF DESCRIPTION OF THE DRAWINGS

FIG. 1A is a system diagram illustrating an example communications system in which one or more disclosed embodiments may be implemented;

FIG. 1B is a system diagram illustrating an example wireless transmit/receive unit (WTRU) that may be used within the communications system illustrated in FIG. 1A according to an embodiment;

FIG. 1C is a system diagram illustrating an example radio access network (RAN) and an example core network (CN) that may be used within the communications system illustrated in FIG. 1A according to an embodiment;

FIG. 1D is a system diagram illustrating a further example RAN and a further example CN that may be used within the communications system illustrated in FIG. 1A according to an embodiment;

FIG. 2 illustrates an example of (e.g., NR) DM-RS symbol configuration Type 1 for 4×4 MIMO.

FIG. 3 illustrates an example of DM-RS based channel estimation and equalization.

FIG. 4 illustrates an example of a DM-RS data channel structure.

FIG. 5 illustrates an example of a DMRS-free data channel structure.

FIG. 6 illustrates example views in a DM-RS free data channel structure.

FIG. 7 illustrates an example of CCA-based data channel processing by a WTRU.

FIG. 8 illustrates example configurations/formats for CCA views with example ranges of values for the delay spread to Doppler ratio (SDR).

FIG. 9 illustrates examples of CCA view configurations (e.g., repetition type) for performance evaluation.

FIG. 10 illustrates example CCA sub-grids and CCA views per sub-grid.

FIG. 11 illustrates example SER results (e.g., simulation results) for different CCA view configurations (e.g., different repetition types) in frequency selective and/or fast fading channels.

FIG. 12 illustrates an example of CCA performance for different view lengths 6≤N≤20.

FIG. 13 illustrates examples of CCA performance for different view lengths 40≤N≤160.

FIG. 14 illustrates example SER results for equal and non-overlapping sub-grids in a CDL-C channel with delay spread of 30 ns and a WTRU velocity of 1 km/hour.

FIG. 15 illustrates an example plot of SER versus SNR for data transmitted over a CDL-C channel and a resource grid of 52 RBs with sub-grid size of 4 RBs.

FIG. 16 illustrates an example of a sub-grid and sub-band size relation, where REs within sub-band SBn may be pre-coded with the precoder fₙ.

FIG. 17 illustrates an example plot of SER versus SNR for different sub-grid sizes in a resource grid of 48 RBs and sub-band size of 6 RBs.

FIG. 18 illustrates examples of DM-RS patterns.

FIG. 19 illustrates examples of CCA patterns. The lines shown in the examples separate the groups of REs combined with the same combiner.

FIG. 20 illustrates examples of CCA and DM-RS based throughput versus SNR for an RG of 52 RBs and a sub-grid size of 4 RBs.

FIG. 21 illustrates examples of CCA and DM-RS based throughput versus SNR for an RG of 52 RBs.

FIG. 22 illustrates an example of determining and reporting CCA sub-grid parameters.

FIG. 23 illustrates an example associated with fall back to DM-RS data transmission, where a WTRU may perform one or more of the illustrated actions.

FIG. 24 illustrates an example associated with a determination of (e.g., preferred) CCA repetition type and parameters, where a WTRU may perform one or more of the illustrated actions.

### DETAILED DESCRIPTION

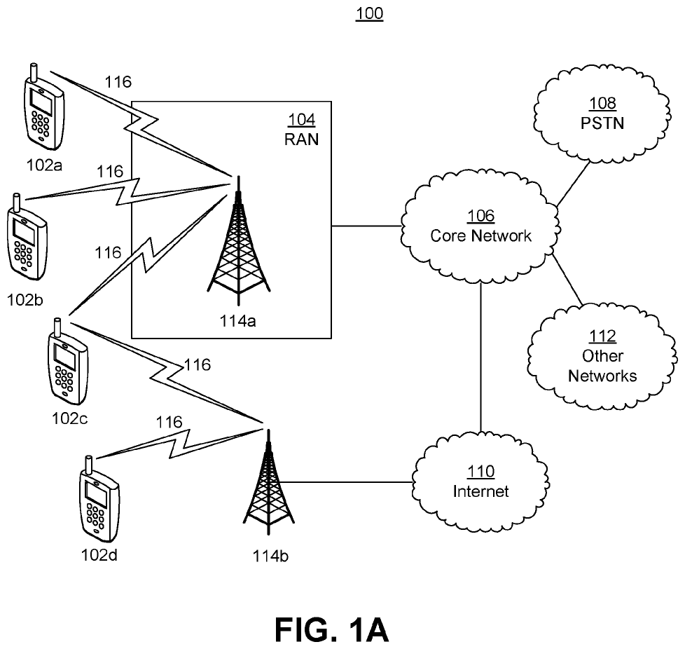

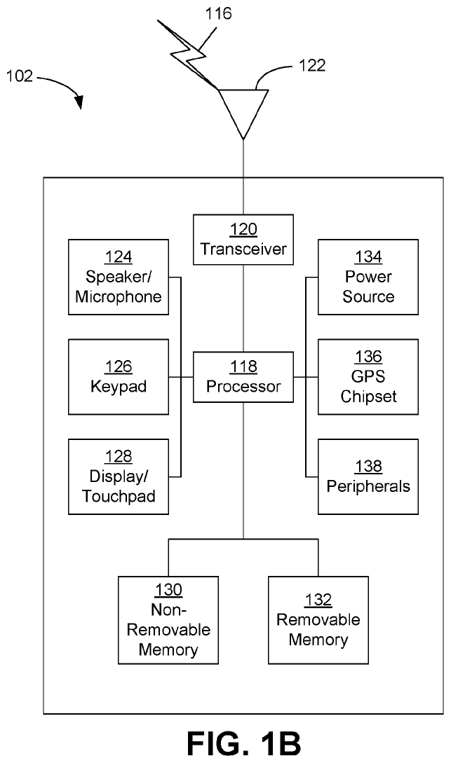

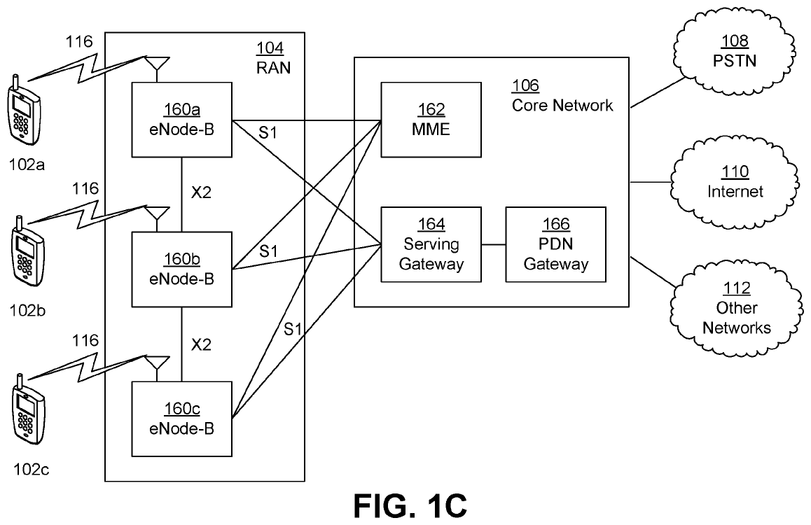

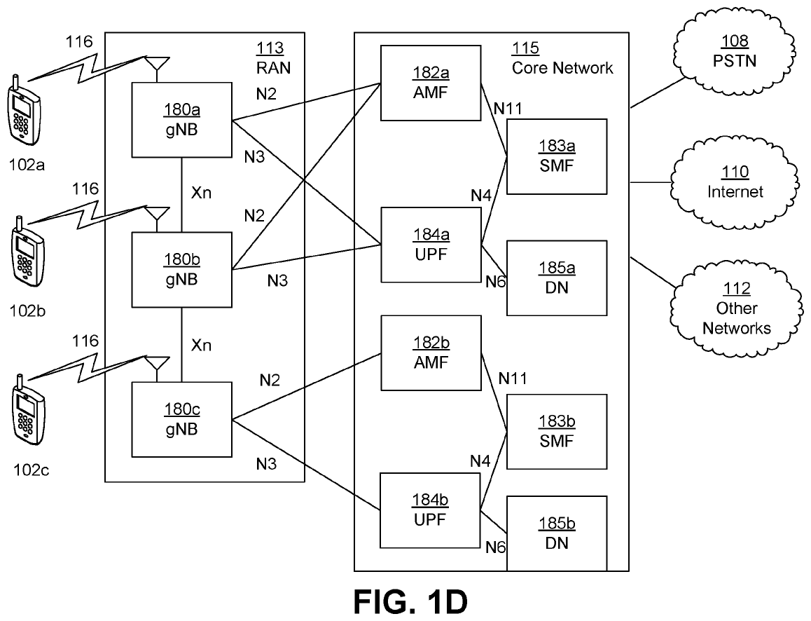

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word DFT-Spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a RAN 104/113, a CN 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106/115, the Internet 110, and/or the other networks 112. By way of example, the base stations 114a, 114b may be a base transceiver station (BTS), a Node-B, an eNode B, a Home Node B, a Home eNode B, a gNB, a NR NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 115/116/117 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed UL Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing a NR radio technology, the CN 106/115 may also be in communication with another RAN (not shown) employing a GSM, UMTS, CDMA 2000, WiMAX, E-UTRA, or WiFi radio technology.

The CN 106/115 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/113 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the UL (e.g., for transmission) and downlink (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WRTU 102 may include a half-duplex radio for which transmission and reception of some or all of the signals (e.g., associated with particular subframes for either the UL (e.g., for transmission) or the downlink (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (or PGW) 166. While each of the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have an access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier Sense Multiple Access with Collision Avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications, such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (COMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one Session Management Function (SMF) 183a, 183b, and possibly a Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different PDU sessions with different requirements), selecting a particular SMF 183a, 183b, management of the registration area, termination of NAS signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for machine type communication (MTC) access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-b, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

Systems, methods, and instrumentalities are described herein for demodulation reference signal (DM-RS) free operation in wireless systems. A data channel structure (e.g., DM-RS free data channel structure) may be used. The DM-RS free data channel structure may enable unsupervised DM-RS free equalization. The DM-RS free data channel structure may enable reporting performance indicators and parameters associated with the DM-RS free data channel structure.

A WTRU may perform canonical correlation analysis (CCA) (e.g., associated with a DM-RS free data channel structure). The WTRU may receive configuration information (e.g., CCA configuration information). The configuration information may indicate CCA view parameter(s) and/or CCA view(s). The CCA view parameter(s) may include one or more of the following: a location of a repeated resource element, a CCA view length, a start symbol, a resource block offset, a mapping order, a CCA reference signal configuration, and/or the like. The WTRU may determine CCA view(s), for example, based on the configuration information. A CCA view may include a group of REs. For example, the first CCA view may have a first group of REs and the second CCA view may have a second group of REs (e.g., where the second group of REs may be a copy of the first group of REs). A CCA view may be associated with a CCA view length, where the CCA view length may be associated with a repetition pattern density. The WTRU may determine (e.g., based on the configuration information) a first CCA view and a second CCA view. The WTRU may measure a CCA correlation coefficient associated with the first CCA view and the second CCA view. The WTRU may determine CCA sub-grid information (e.g., sub-grid size, number of sub-grids, and/or number of CCA reference signals (CCA-RSs) (e.g., per sub-grid), for example, based on the first CCA view, the second CCA view, and the CCA correlation coefficient. A determined sub-grid size may be a number of resource blocks (RBs). The WTRU may determine whether to send an indication of the determined sub-grid size based on whether the determined sub-grid size is equal to a configured sub-band size. The WTRU may send a report (e.g., to the network) based on the determination of whether to send the indication of the sub-grid size. The report may indicate the determined number of CCA-RSs and the CCA correlation coefficient. The WTRU may demodulate and equalize the data channel, for example, with a received CCA-RS, the first CCA view, and the second CCA view.

The WTRU may determine that the determined sub-grid size does not equal the configured sub-band size. Based on the determination that the determined sub-grid size does not equal the configured sub-band size, the report may indicate the determined sub-grid size.

The WTRU may receive a channel state information reference signal (CSI-RS). The WTRU may perform a measurement based on the CSI-RS. The determination of the CCA sub-grid information may be performed, for example, based on the performed measurement based on the CSI-RS.

A data channel structure as described herein may enable unsupervised DM-RS free equalization. A mobile terminal (e.g., WTRU, STA) may determine and/or report to a base station (e.g., gNB, access point (AP), etc.) one or more performance indicators and/or parameters of a DMRS-free data channel structure.

A data channel structure such as disclosed herein may employ a repetition protocol to enable unsupervised, DM-RS free equalization. The repetition structure may be utilized at the receiver, for example, by creating multiple (e.g., two) data views (e.g., referred to as canonical correlation analysis (CCA) views). The repetition based data channel structure may enable unsupervised equalization, e.g., using CCA.

Features associated with determining a preferred CCA sub-grid size are disclosed herein. A WTRU may be configured with CCA views for a data channel. The WTRU may measure a CCA correlation coefficient, e.g., based on received CCA views. The WTRU may determine one or more of: a CCA sub-grid size, e.g., based on received CCA view, measured CCA correlation coefficient, and/or configured CSI sub-band size or PRG size; or a number of CCA-RSs (e.g., pilots) per sub-grid, e.g., based on SNR, RSRP/RSRQ, and/or CCA view length per sub-grid. The WTRU may report a preferred CCA sub-grid size, CCA correlation coefficient per sub-grid, and/or preferred number of CCA-RSs per sub-grid, e.g., if the determined CCA sub-grid size is different from the configured sub-band size/PRG size. The WTRU may demodulate and equalize the data channel with the received CCA view and CCA-RS.

Features associated with WTRU fallback to legacy DM-RS are disclosed herein. A WTRU may be configured for CCA processing for a data channel. The WTRU may receive a CCA view configuration from a network device, such as a base station (e.g., gNB). The WTRU may receive the CCA-enabled data channel. The WTRU may determine combiners based on configured CCA views. The WTRU may measure a CCA correlation coefficient between the CCA views. The WTRU may compare the CCA correlation to a configured threshold. The WTRU may determine if there is a need to fallback to legacy, e.g., based on the measured CCA correlation coefficient satisfying the threshold (e.g., being lower than the configured CCA correlation coefficient threshold).

A channel structure (e.g., a new data channel structure), e.g., for low RS overhead and low complexity, may be defined herein. CCA view structure and related parameters may be associated with the channel structure, e.g., CCA view length, CCA repetition type, CCA multi-layer repetition offset, and/or CCA-RS. WTRU measurements of CCA parameters may be performed, e.g., CCA correlation coefficient may be measured.

Determination of CCA parameters may be described herein. A WTRU may determine the view length and repetition configuration type, e.g., as a function of the measured channel. The WTRU may determine the CCA sub-grid size as a function of a configured CCA view, measured CCA correlation coefficient, and/or PRG size. The WTRU may determine the number of CCA-RSs, e.g., based on SNR and/or CCA view length per sub-grid.

Demodulation reference signal (DM-RS)-free operation may be implemented in wireless systems. A data channel structure may enable unsupervised DM-RS free equalization. A mobile terminal (e.g., WTRU, STA) may determine and/or report to a network (e.g., a base station, such as a gNB and/or an access point (AP)) one or more performance indicators and/or parameters of a DMRS-free data channel structure.

A network (e.g., 5G NR) may include various types of reference signals (RS) that may be used for different purposes. For example, demodulation reference signals (DM-RS) may be used for estimating the effective (e.g., precoded) channel response for coherent demodulation of the physical downlink shared channel (PDSCH) and/or physical uplink shared channel (PUSCH). DM-RS based channel estimators may use a (e.g., large) number of DM-RS, for example, to support (e.g., ensure acceptable) channel estimation performance, which may result in an increase in overhead and/or (e.g., in turn) impact the (e.g., overall) spectral efficiency. Reducing overhead may affect channel estimation, which may lead to degradation in data equalization performance. In some examples (e.g., for multi-layer transmissions, such as simple user (SU)- or multiple user (MU)-multiple input multiple output (MIMO)), the DM-RS associated with different layers and/or users (e.g., in a MU-MIMO setup) may be orthogonal. Maintaining orthogonality may involve (e.g., tight) coordination between different base stations (e.g., gNB, AP), which may be difficult to satisfy in multicell networks.

Artificial intelligence (AI)/machine learning (ML) based techniques (e.g., which may include supervised and/or unsupervised learning) may be used to address (e.g., avoid or overcome) RS-based techniques (e.g., the limitations of RS-based techniques). A Canonical Correlation Analysis (CCA) (e.g., an ML tool) may enhance data equalization performance (e.g., in an unsupervised fashion), for example, at low complexity. Canonical correlation analysis may be a statistical machine learning technique that can extract latent common representation from multiple (e.g., two) data views. The common components may be extracted, for example, by finding linear projections of the multiple (e.g., two) data views (e.g., linear CCA). The common components may be extracted, for example, by finding non-linear projections (e.g., referred to as Kernel CCA (KCCA) or Deep CCA (DCCA)).

A data channel structure may employ a (e.g., simple) repetition protocol to enable unsupervised, DM-RS free equalization. The repetition structure may (e.g., then) be utilized at the receiver, for example, by creating multiple (e.g., two) data views (e.g., referred to as CCA views). The CCA views may enable unsupervised equalization using canonical correlation analysis (CCA).

CCA view and/or parameters (e.g., preferred CCA view and/or parameters) may be determined. Parameters determined may include, for example, one or more of the following: CCA view length; density in time or frequency domain; mapping (e.g., time first/frequency first), which may be determined as a function of the measured channel parameters (e.g., based on CSI-RS); etc. The CCA view may be configured with PRB bundling. The WTRU may indicate the CCA parameters. In examples (e.g., for a WTRU operating with CCA based data channels (DM-RS free), the WTRU may determine whether it is better to fall back to legacy DM-RS operation. A repetition type (e.g., time vs. frequency) may be determined. Multi-layer/SU-MIMO operation may be enabled for CCA based DM-RS free operation.

Features associated with determining a preferred CCA sub-grid size are disclosed herein. A WTRU may determine (e.g., be configured with) CCA views for a data channel. The WTRU may measure a CCA correlation coefficient, e.g., based on received CCA views. The WTRU may determine one or more of: a CCA sub-grid size, e.g., based on received CCA view, measured CCA correlation coefficient, and/or configured CSI sub-band size or PRG size; a number of CCA-RSs (e.g., pilots) per sub-grid, e.g., based on signal to noise ratio (SNR), reference signal received power (RSRP)/reference signal received quality (RSRQ), and/or CCA view length per sub-grid. The WTRU may report a preferred CCA sub-grid size, CCA correlation coefficient per sub-grid, and/or preferred number of CCA-RSs per sub-grid, e.g., if the determined CCA sub-grid size is different from the configured sub-band size/PRG size. The WTRU may demodulate and equalize the data channel with the received CCA view and CCA-RS.

Features associated with WTRU fallback to legacy DM-RS are disclosed herein. A WTRU may be configured for CCA processing for a data channel. The WTRU may receive a CCA view configuration from a network device, such as a base station (e.g., gNB). The WTRU may receive the CCA-enabled data channel. The WTRU may determine combiners based on configured CCA views. The WTRU may measure a CCA correlation coefficient between the CCA views. The WTRU may compare the CCA correlation to a configured threshold. The WTRU may determine if there is a need to fallback to legacy, e.g., based on the measured CCA correlation coefficient satisfying the threshold (e.g., being lower than the configured CCA correlation coefficient threshold).

A channel structure (e.g., a new data channel structure), e.g., for low RS overhead and low complexity, may be defined herein. CCA view structure and related parameters may be associated with the channel structure, e.g., CCA view length, CCA repetition type, CCA multi-layer repetition offset, and/or CCA-RS. WTRU measurements of CCA parameters may be performed, e.g., CCA correlation coefficient may be measured.

Determination of CCA parameters may be described herein. A WTRU may determine the view length and repetition configuration type, e.g., as a function of the measured channel. The WTRU may determine the CCA sub-grid size as a function of a configured CCA view, measured CCA correlation coefficient, and/or precoding resource block group (PRG) size. The WTRU may determine the number of CCA-RSs, e.g., based on SNR and/or CCA view length per sub-grid.

Machine learning (ML) may refer to a type of algorithm(s) that solve a problem based on learning through experience (e.g., data), for example, without (e.g., explicitly) being programmed (e.g., configuring a set of rules). Machine learning may be considered as a subset of artificial intelligence (AI). Different machine learning paradigms may be utilized, for example, based on the nature of data or feedback available to the learning algorithm. For example, a supervised learning approach may involve learning a function that maps input to an output based on a labeled training example. A (e.g., each) training example may include a pair that includes an input and a corresponding output. An unsupervised learning approach may involve detecting patterns in the data without pre-existing labels. For example, a reinforcement learning approach may involve performing a sequence of actions in an environment to maximize the cumulative reward. In some examples, machine learning algorithms may be applied using a combination or interpolation of one or more approaches, e.g., as described herein. For example, a semi-supervised learning approach may use a combination of (e.g., a small amount of) labeled data with (e.g., a large amount of) unlabeled data during training. Semi-supervised learning may fall between unsupervised learning (e.g., without labeled training data) and supervised learning (e.g., with only labeled training data).

Deep Learning (DL) may refer to a class of machine learning algorithms that employ artificial neural networks (e.g., deep neural networks (DNNs)), which may be based on (e.g., loosely inspired by) biological systems. Deep Neural Networks (DNNs) may be a (e.g., special) class of machine learning models inspired by the human brain. The input to a DNN may be linearly transformed and/or may pass-through a non-linear activation function multiple times. DNNs may include multiple layers. A (e.g., each) layer may include linear transformation and/or one or more non-linear activation functions. DNNs may be trained, for example, using the training data via a back-propagation algorithm. DNNs may provide state-of-the-art performance in variety of domains (e.g., speech, vision, natural language, etc.) and/or for various machine learning settings (e.g., supervised, un-supervised, and/or semi-supervised). Artificial intelligence markup language (AIML) based methods/processing may refer to realization of behaviors and/or conformance to requirements by learning based on data, e.g., without a configuration (e.g., an explicit configuration) of a sequence of steps of actions. AIML-based methods may enable learning complex behaviors that might be difficult to specify and/or implement (e.g., if/when using legacy methods).

Factor analysis techniques may be used in machine learning, data analytics, and/or signal processing. For example, principal component analysis (PCA), coupled matrix factorization (CMF), independent component analysis (ICA), and/or canonical correlation analysis (CCA), may be used in compression, dimensionality reduction, visualization, subspace estimation, etc. Factor analysis techniques may operate in an unsupervised manner under one or more (e.g., different) objectives, for example, depending on the considered application. Some factor analysis tools may extract latent components from one or more data view/matrices (e.g., PCA, ICA). Some factor analysis tools may recover latent common information from multiple data views/matrices (e.g., CMF, CCA).

Canonical correlation analysis (CCA) may include a machine learning technique that may be used in different fields of machine learning and/or signal processing. CCA may include a multiview analysis technique that may be used to discover latent common information between multiple (e.g., two) data views. Single-view analysis techniques (e.g., PCA) may be used to extract (e.g., strong) components from a data matrix. Multi-view analysis tools (e.g., CCA) may be used to (e.g., jointly) analyze different views of the data. CCA may be (e.g., from an optimization perspective) based on a “differential” criterion that causes (e.g., forces) CCA to zoom in (e.g., focus, consider, etc.) on (e.g., only) what is common between different views. One or more views may include a (e.g., very) strong component that is absent from another view. CCA can ignore principal components (e.g., no matter how strong they are), for example, as long as they are not common. CCA may operate in a linear fashion (e.g., referred to as linear CCA) and/or a non-linear fashion (e.g., referred to as Kernel CCA (KCCA), deep CCA (DCCA), and/or non-linear CCA). Linear CCA may extract latent common features, for example, by finding (e.g., two) linear projections of the (e.g., two) data views. Non-linear CCA may extract latent common features, for example, by finding (e.g., generally) non-linear projections of the data views (e.g., based on DNN).

CCA may find two vectors q₁∈ [symbol] ^{N}^{ᵣ} and q₂∈ [symbol] ^{N}^{ᵣ} (e.g., referred to as CCA canonical vectors and/or CCA combiners). The resulting N-dimensional components from the two linear projections Y₁q₁∈ [symbol] ^{N} and Y₂q₂ [symbol] ^{N} may be (e.g., maximally) correlated. The expressions Y₁∈ [symbol] ^{N×N}^{ᵣ} and Y₂∈ [symbol] ^{N×N}^{ᵣ} may be two data views. In some examples (e.g., in an optimization framework), the CCA formulation may be given in accordance with Eq. (1):

$${min}_{{q}_{1} , {q}_{2} {‖ {Y}_{1} {q}_{1} ‖}_{2}^{2} = 1 , {‖ {Y}_{2} {q}_{2} ‖}_{2}^{2} = 1} {‖ {Y}_{1} {q}_{1} - {Y}_{2} {q}_{2} ‖}_{2}^{2} \qquad ( 1 )$$

Scaling constraints may serve to exclude (e.g., all) zero and/or meaningless solutions. An (e.g., a simple) algebraic solution via eigenvalue decomposition may be implemented. The (e.g., overall) complexity may involve solving for a principal eigenvector of a matrix that involves multiplication of auto- and/or cross-covariance matrices.

Demodulation Reference Signals (DM-RS) may be used to demodulate signals. Coherent demodulation of signals transmitted over a radio interface may use (e.g., require) knowledge of a (e.g., precoded/effective) wireless channel. A channel estimation process at a receiver in an NR may use (e.g., rely on) the transmission of physical channels accompanied by one or more demodulation reference signals (DM-RS). DM-RSs may be generated using pseudo-random sequences, which may be based on one or more system parameters that may be known to the receiver. Parameters used to control sequence generation may include, for example, one or more of a scrambling identity, symbol locations, number of OFDM symbols in a slot, etc. DM-RS operation in a network (e.g., NR) may include one or more (e.g., several) predefined options for patterns (e.g., uniform/equally spaced) and/or densities of RSs, which may be based on the physical channels. RSs may be configured, for example, using scheduling (e.g., DCI-based) and/or (e.g., high-layer) configuration information to cater to different use cases and/or WTRU capabilities.

Configuration of a DM-RS may include configuration of one or more of the following: a density and/or a pattern in a resource grid; a duration; a starting symbol (e.g., front-loaded DM-RS), and/or cover codes, e.g., to differentiate between antenna ports, which may share the same time/frequency resources (e.g., for single-user and/or multi-user MIMO cases). The set of parameters for a DM-RS may be set (e.g., may be different), for example, depending on the physical channel and/or depending on WTRU capability. In some examples (e.g., for PDSCH DM-RS), there may be one or more of the following: a Configuration Type 1 or Type 2, a Mapping Type A or Type B, a Starting Symbol for Mapping Type A, Single versus Double Symbol DM-RS, DM-RS Additional Positions, and/or a duration. DM-RS may be grouped over one or more (e.g., several) resource blocks. For example, the precoder may be constant, e.g., the receiver may perform wideband channel estimation.

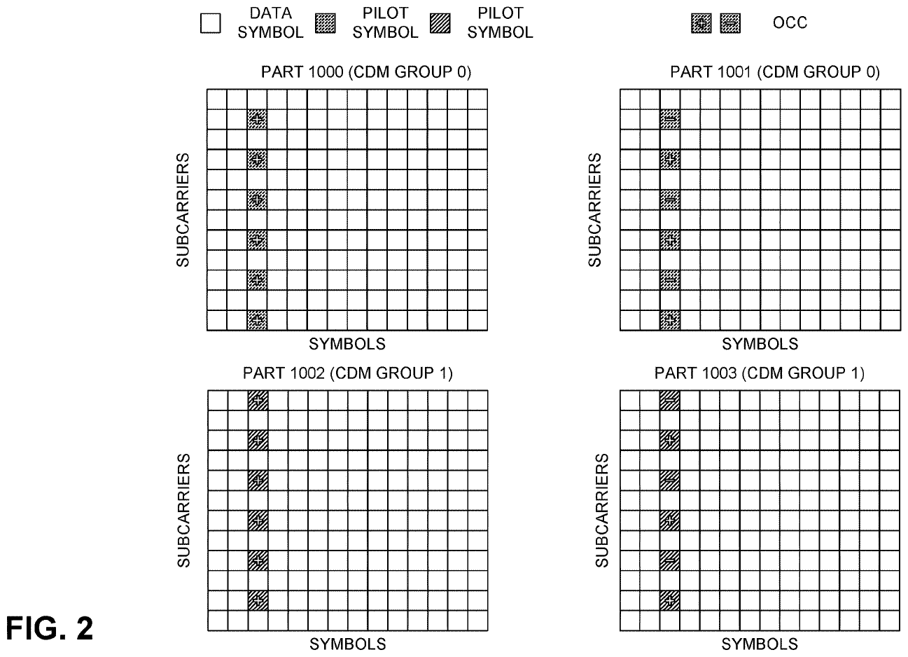

The selection of DM-RS may be carried out by (e.g., based on) a (e.g., higher-layer) configuration (e.g., configuration information) and/or dynamic (e.g., DCI-based) signaling. In some examples, there may be a default configuration. FIG. 2 shows an example of a DM-RS pattern over a (e.g., one) symbol and a (e.g., one) resource block in a network (e.g., NR). In some examples (e.g., as shown in FIG. 2) a DM-RS may be configured with Configuration Type 1, Mapping Type A, and Starting Symbol 3, using downlink antenna ports 1000-1003, with CDM grouping across the frequency and code domains. A network (e.g., base station) may signal selection of DM-RS settings to a terminal (e.g., WTRU). The network (e.g., base station) may signal settings, for example, using RRC, MAC-CE, and/or PDCCH/DCI.

The terminal (e.g., WTRU) may utilize the DM-RS for Channel estimation and/or (e.g., coherent) demodulation of the corresponding physical channels. Channel estimation (e.g., and demodulation) may be achieved, for example, using a receiver filter implementation (e.g., Least Squares, Minimum Mean Squared Error (MMSE), etc.), which may estimate the composite channel by mapping the transmitted layers onto the receive antennas for the resource blocks that are scheduled.

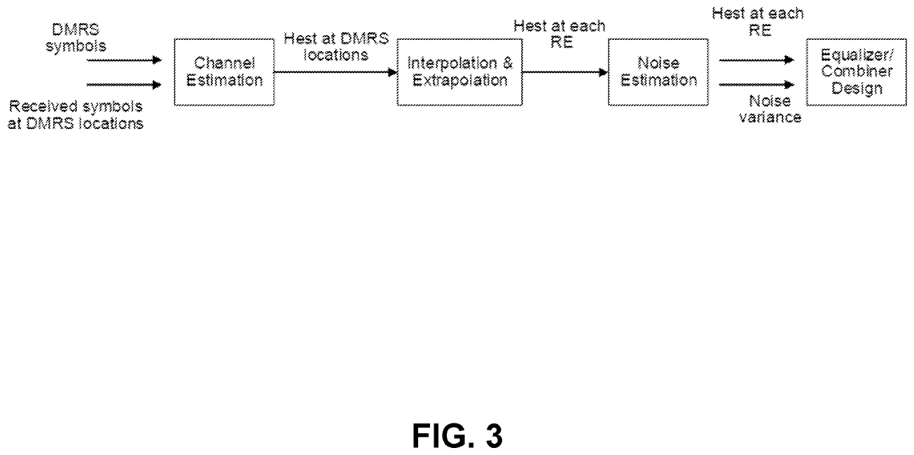

A channel estimation process may include, for example, one or more of the following: (i) the receiver may determine the estimates of the channels of the DMRS symbols from their known locations in the received slots, where an averaging window may be used to minimize the effects of noise; (ii) multi-dimensional interpolation and extrapolation operations may be used to estimate missing values associated with (e.g., all) other resource elements (REs) from the channel estimation grid; (iii) noise power estimation, which may be performed to improve performance by comparison of direct and/or average channel estimates; (iv) the terminal (e.g., WTRU) may use the channel and noise estimates to design an equalizer (e.g., MMSE); and/or (v) the terminal (e.g., WTRU) may perform (e.g., coherent) OFDM demodulation of precoded/beamformed physical channels. FIG. 3 shows an example an end-to-end DM-RS framework.

FIG. 2 illustrates an example of (e.g., NR) DM-RS symbol configuration Type 1 for 4×4 MIMO. FIG. 3 illustrates an example of DM-RS based channel estimation and equalization.

The following notations are provided for one or more examples described herein: Nₜ may be the number of transmit antennas; Nᵣ may be the number of receive antennas; Nₛ may be the number of streams (e.g., the number of streams Nₛ and the number of layers N_{L} may be used interchangeably herein); N may be the number of REs per view, the number of symbols per view, and/or the CCA view length; and N_{CCA-RS} may be the number of reference signals for CCA complex scaling ambiguity resolution.

Data channels may be equalized and/or demodulated, for example, using channel estimation. A WTRU (e.g., a 3GPP mobile terminal) may use DM-RS to estimate the effective (e.g., precoded) channel response experienced by the receiver, for example, which may be (e.g., subsequently) used for equalization and/or demodulation. The quality of the channel estimate may (e.g., directly) impact the equalization performance and/or the channel/link performance. A large number of DM-RS symbols may be used to achieve channel estimation (e.g., acceptable channel estimation performance), which may result in high DM-RS overhead and/or negative impacts to spectral efficiency. Reducing the number of DM-RS symbols may reduce the RS overhead and/or degrade the channel estimation performance, which may degrade the link performance. In some examples (e.g., for multi-layer transmissions (SU- or MU-MIMO)), DM-RS signals across different layers/users may (e.g., need to) be orthogonal, which may (e.g., further) increase the DM-RS overhead, for example, as the number of layers/co-scheduled users increases.

Implementation complexity for such approaches may be high, for example, if channel estimators use (e.g., additional) processing blocks, such as one or more of the following: noise estimators, Doppler estimators, interpolation and/or extrapolation to (e.g., all) REs in the allocated channel.

Loss of orthogonality of the DM-RS may result in poor channel estimation performance, which may degrade system performance.

One or more limitations of the DM-RS based approach may include, for example, RS overhead, implementation complexity, and/or performance degradation (e.g., due to loss of orthogonality in multicell networks).

Features associated with a CCA based processing configuration are disclosed herein. A data channel structure may be implemented with low overhead and/or low complexity.

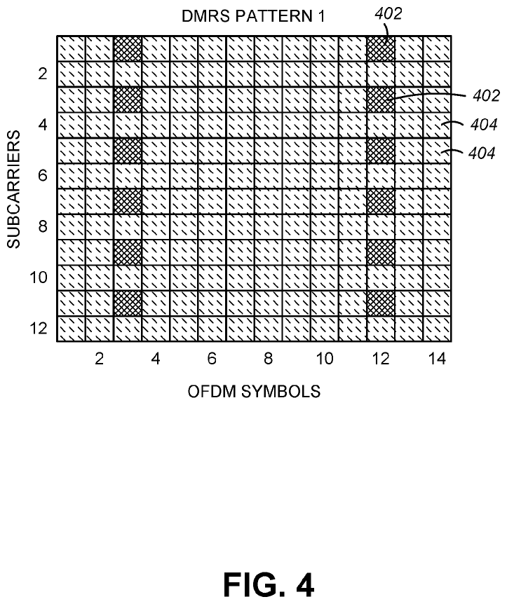

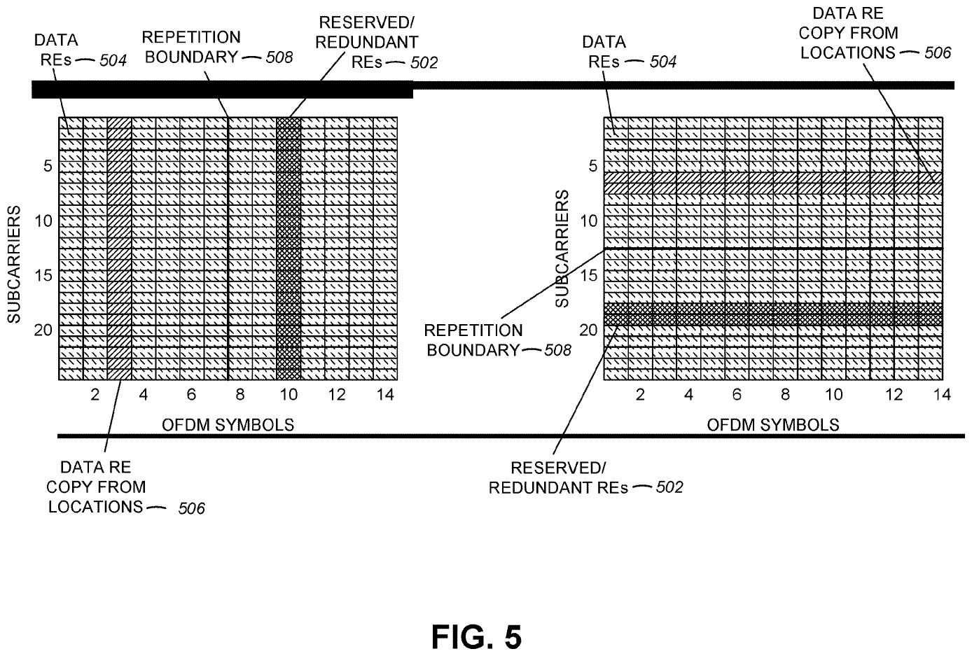

Data channel structure(s) described herein may not include DM-RSs (e.g., any DM-RS), which may be different from a data channel structure that includes reserved REs for DM-RS, e.g., as shown in FIG. 4. A data channel structure for CCA processing is shown and described herein for a WTRU (e.g., supporting CCA-based processing). The data structure may repeat one or more (e.g., a few) data symbols in the time-frequency grid, e.g., as shown by example in FIG. 5. Repetition may be employed in time and/or frequency (e.g., a hybrid of time and frequency). Different repetition patterns may yield different performance. A repetition structure may be utilized at the WTRU side to derive CCA combiners, which may be used to decode PDSCH data in the repeated locations, e.g., and the data in their neighborhood.

FIG. 4 illustrates an example of a DM-RS data channel structure. FIG. 4 shows reserved REs 402 for DM-RS and data REs 404.

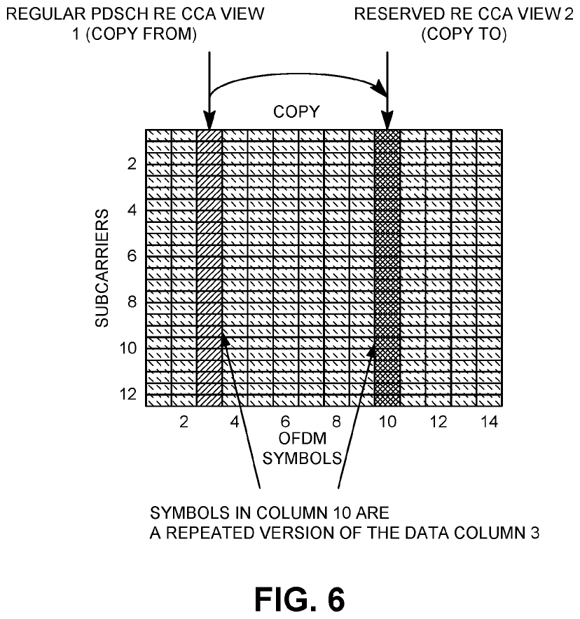

FIG. 5 illustrates an example of a DMRS-free data channel structure. FIG. 5 shows reserved/redundant REs 502 (e.g., because of repetition), data REs 504, and data RE “copy from” locations 506. FIG. 6 illustrates example views in a DM-RS free data channel structure.

A repetition-based data structure may include, for example, one or more of the following parameters: RepetitionConfigType; RepetitionReservedStartSymbolIndex; RepetitionReservedAddPos; RepetitionReservedLengthPerSymbol; CCAViewsOffset; RepetitionReservedStartSubcarrierIndex; NrofCCARS; and/or MultilayerRepetitionOffset.

The parameter RepetitionConfigType may indicate the adopted repetition type at the gNB. The parameter may be one bit, indicating, for example, whether it is a time repetition or frequency repetition. The parameter may be more than one bit, for example, to indicate more types (e.g., hybrid). A WTRU may assume a default (e.g., time repetition), for example, if the field is absent/not indicated.

The parameter RepetitionReservedStartSymbolIndex may represent/indicate the start of an OFDM symbol index, which may include the reserved REs. The parameter RepetitionReservedStartSymbolIndex may also represent/indicate the OFDM symbol index of the start of the copy-to locations. The parameter RepetitionReservedStartSymbolIndex may be used (e.g., only) in conjunction with the time repetition. For example, the parameter RepetitionReservedStartSymbolIndex may be set to 10 (e.g., as shown by example in FIG. 5 (left).

The parameter RepetitionReservedAddPos may indicate the number of additional symbols that include reserved REs. The repetition parameter may be considered for (e.g., only) half a slot. The repetition parameter may have values such as 1 or 2, for example, where 1 may represent one additional symbol and/or 2 may represent two additional symbols. The WTRU may be configured with a maximum of three OFDM symbols, which may carry reserved elements. The WTRU may assume a default (e.g., only one symbol for the index signaled under the field RepetitionReservedStartSymbolIndex), for example, if the repetition field is absent/not indicated.

The parameter RepetitionReservedLengthPerSymbol may indicate the gap between the reserved REs in the OFDM symbol (e.g., frequency density). The parameter may have values, such as (0, 1, 2, 3), for example, where 0 may indicate that (e.g., all) subcarriers are reserved for the considered start symbol index. In some examples (e.g., as shown in FIG. 5 (left), the parameter may be set to 0.

The parameter CCAViewsOffset may represent the time/frequency offset between multiple (e.g., two) CCA views (e.g., “copy-to” and “copy-from” locations). The parameter may have values for time repetition, such as four values within the range 1 to 13. For example, if the start OFDM symbol for reserved REs is set to 13, then the offset may be at most 13, which may indicate that the copy-from location is or should be the data in OFDM symbol 0. A WTRU may find the copy-from (the other CCA view) location, for example, by subtracting the RepetitionSymbolOffset from RepetitionReservedStartSymbolIndex.

The parameter RepetitionReservedStartSubcarrierIndex may represent the start subcarrier index, which may include the reserved REs. The parameter RepetitionReservedStartSubcarrier Index may (e.g., also) represent/indicate the subcarrier index of the start of the copy-to-locations. The parameter may be used (e.g., only) in conjunction with the frequency repetition.

The parameter NrofCCARS may indicate the number of configured CCA-RS for CCA scaling ambiguity resolution.

The parameter MultilayerRepetitionOffset may allow a WTRU to identify the repetition patterns associated with other transmitted layers. For example, the parameter may indicate pseudo-random seeds that the WTRU may use on the top of the reference pattern (e.g., the reference pattern used for layer 1) to find the other patterns. In some examples, the parameter may indicate a shift in time and/or frequency between the reference pattern and one or more other layers' patterns.

In some examples, the WTRU may be configured with a set of (e.g., known) patterns, which may include repetition in time and/or frequency. The adopted pattern may be signaled to the WTRU, for example, to construct the (e.g., two) views. In some examples, the WTRU may be configured with multiple (e.g., two or more) subsets. For example, there may be a subset for a (e.g., each) repetition type, e.g., with different densities. The WTRU may be configured with one of the patterns associated with a subset (e.g., associated with any of the subsets).

A WTRU may perform CCA-based processing.

A WTRU may (e.g., based on/upon receiving the PDSCH transmission with a repetition-based data structure) construct the (e.g., two) CCA views Y₁ and Y₂ (e.g., Y₁∈ [symbol] ^{N×N}^{ᵣ} and Y₂∈ [symbol] ^{N×N}^{ᵣ}). Parameter N may be defined as the number of REs per view, the number of symbols per view, and/or the CCA view length (e.g., as described herein). Parameter Nᵣ may be the number of receive antennas. The WTRU may (e.g., once the two views are constructed) drive the CCA combiners q1 and q2 (e.g., q1∈ [symbol] ^{N}^{ᵣ} and q2∈ [symbol] ^{N}^{ᵣ}), for example, by solving for the CCA, e.g., as shown by example in Eq. (1). The WTRU may (e.g., then) apply the derived combiners to the (e.g., entire) received signal (e.g., Y∈ [symbol] ^{N}^{_{data}}^{×}^{ᵣ}), for example, to decode the PDSCH data symbols. Parameter N_{data} may be the total number of data symbols in the received resource grid. The WTRU may choose one of the combiners (e.g., q₁ or q₂), for example, to combine (e.g., all) the data REs in the received resource grid, which may occur, for example, if the (e.g., two) combiners are identical or close to each other (e.g., up to ϵ). In some examples, the WTRU may (e.g., choose to) combine part of the data using q₁ and the other part with q₂. For example, q₁ may be used to combine the REs in the vicinity of the symbols in a first CCA view while q₂ may be used to combine the REs in the vicinity of the symbols in a second CCA view (e.g., as described herein). The WTRU may (e.g., also) compute (e.g., measure) and/or report the resulting CCA correlation coefficient, which may be determined, for example, in accordance with Eq. (2):

$$CCACorrCoefficient ( ρ ) = {q}_{1}^{T} {Y}_{1}^{T} {Y}_{2} {q}_{2} \qquad ( 2 )$$

The value of parameter p may be 0≤ρ≤1. Parameter ρ may be a CCA-related parameter that indicates detection performance.

Recovered data signal post-CCA combining may be subject to a (e.g., complex) scaling ambiguity, which may be part of (e.g., inherent to) the CCA. The scaling ambiguity may be resolved, for example, using a type of reference signal (RS), which may be referred to as CCA-RS (e.g., as described herein). A WTRU may be configured with a CCA-RS location(s), e.g., number (N_{CCA-RS}), and/or symbol sequence(s), which may be known at the WTRU and the network (NW). The symbols may be used (e.g., solely) for the complex scaling ambiguity resolution.

A WTRU may perform the procedures repeatedly/multiple times, for example, based on the allocated BWP. The WTRU may solve multiple CCA problems (e.g., in parallel), for example, depending on the resource grid size and/or the channel conditions (e.g., as described herein).

A WTRU may be configured for CCA based processing. A WTRU may be configured, for example, with a higher layer parameter DataStructureType, which may be one bit indicating whether the received data channel structure is for CCA reception or DM-RS reception. For example, if DataStructureType is set to ‘1’, the WTRU may assume CCA processing, and otherwise (e.g., if DataStructureType is set to ‘0’), the WTRU may assume DM-RS processing. A WTRU may (e.g., if configured for CCA processing) use the CCA parameters and/or the repetition pattern parameters to form the (e.g., two) CCA views that may be used for deriving the combiners. The CCA parameters may include, for example, pattern related parameters (e.g., used to construct the CCA views) and/or a CCA-RS sequence and/or locations (e.g., for CCA scaling correction). The WTRU may be configured with the number of CCA sub-grids (e.g., as described herein) and/or the associated number of CCA-RS in a (e.g., each) configured sub-grid.

Different patterns associated with different layers may be distinct, which may support CCA in multilayer operation. Different patterns may be shifted in time and/or frequency, and/or pattern indices may be a permuted version of each other. A WTRU may be configured with the parameter MultilayerRepetitionOffset, which may allow the WTRU to find the other layer patterns from a reference pattern.

A WTRU may be configured for CCA parameter determination(s). A WTRU may be configured to compute (e.g., measure) and/or report the CCA correlation coefficient(s), for example, if one or more/multiple CCA problems are solved. For example, a WTRU may be configured with multiple CCA sub-grids. The WTRU may report the correlation coefficient associated with each sub-grid. In some examples, the WTRU may report the average correlation coefficient, for example, if multiple CCA problems are solved. In some examples (e.g., in the case of multilayer transmission), a WTRU may be configured to report one or multiple correlation coefficients associated with a (e.g., each) layer.

A WTRU may be configured to determine and/or report one or more (e.g., some) of the CCA-related parameters. For example, a WTRU may be configured to determine the number of CCA sub-grids and/or the needed number of CCA-RS for a (e.g., each) sub-grid. A WTRU may (e.g., also) be configured to determine and/or report the repetition type. A WTRU may (e.g., also) be configured to recommend whether (e.g., it is better) to use (e.g., switch to) CCA processing or DMRS processing.

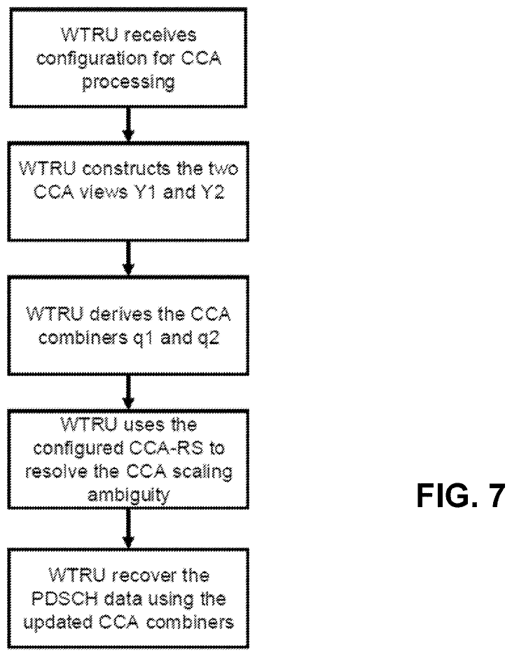

An example of CCA-based data channel processing (e.g., by a WTRU) is shown in FIG. 7.

FIG. 7 illustrates an example of CCA-based data channel processing by a WTRU.

One or more CCA parameters may be determined.

A CCA view format may be determined. A CCA-based method may use multiple (e.g., two) views of the same data, for example, to estimate the equalizer parameters. Estimation of an equalizer (e.g., accurate estimation of an equalizer) may be performed, for example, by having the REs associated with a view observe the same channel with low variation. For example, the channel may be flat (e.g., as flat as possible) for (e.g., all) the REs in a view. Channel characteristics may change gradually across sub-carriers and/or OFDM symbols. The REs suitable for forming the CCA view (e.g., having low variation) may be (e.g., in high likelihood) adjacent to each other within the resource grid and/or may be clustered together.

While the REs within a view maybe clustered together, the (e.g., exact) set and/or the (e.g., exact) format of the REs that contribute to a CCA may be reliant (e.g., heavily reliant) on one or more channel properties, such as delay spread, Doppler, etc. The configuration and/or format of the view may change (e.g., as the properties change), for example, to satisfy a condition that the channel at the REs within a view are as flat as possible.

A CCA view format may be selected, for example, based on one or more (e.g., different) strategies, which may, for example, utilize one or more of the following: one or more optimization techniques, knowledge (e.g., prior knowledge) about the problem being addressed, and/or machine learning/deep learning solutions (e.g., to leverage channel properties and/or raw channel values to select the CCA view format).

A CCA view format may be determined, for example, based on one or more optimization strategies. In some examples, a sub-grid of the channel matrix may have (e.g., a total of) N̅ REs. One or more (e.g., two) of the following objectives may be evaluated, e.g., from a CCA perspective. CCA views may be constructed, for example, based on (e.g., two) non-overlapping subsets of RES S_{1c} and S_{2c}, which may be selected to carry the replicated symbols x_{ci}. In some examples, |S_{1c}|=|S_{2c}|=N, and |S_{1c}|+|S_{2c}|<N̅, e.g., where N may be defined as the view length. The grid of N̅ REs may be divided into (e.g., two) non-overlapping subsets S₁ and S₂, e.g., where |S₁|+|S₂|=N̅. The two subsets may or may not have an equal number of REs. The subsets may mark the elements that may be equalized, e.g., using one of the two CCA based equalizers q₁, q₂. Parameters S_{1c} and S_{2c} may be subsets of S₁ and S₂, respectively.

One or more of the objectives may be modeled as variance minimization formulations, for example, with an objective of splitting the N REs into (e.g., two) non-overlapping subsets. The variance of the channel and/or the channel magnitude across the REs within the subsets may be minimized. A formulation may be modeled as a set partitioning problem, which may be solved as a combinatorial optimization problem.

In some (e.g., alternative) examples, the set partitioning may (e.g., also) be modeled as a clustering problem. Data clustering may be performed. For example, a linear discriminant analysis (LDA)-styled model may be used. An LDA model may have an objective (e.g., a similar objective) of minimizing within cluster variance and/or maximizing across cluster variance. An LDA model may be implemented with a low computational complexity.

A CCA view format may be determined, for example, based on prior knowledge (e.g., of a problem). A WTRU may be configured to determine and/or report a CCA view format. A CCA view format information may include, for example, one or more of the following: a repetition configuration type (e.g., RepetitionConfigType) and/or a repetition boundary.

A repetition configuration type (e.g., RepetitionConfigType) may represent a preferred repetition type (e.g., the location of the (two) views). The repetition type may be (e.g., may indicate) time and/or frequency (e.g., a hybrid), for example, as shown in FIG. 5 (e.g., and described/defined herein).

A repetition boundary may represent the boundary between the (e.g., two) views (e.g., repetition boundary line 508 in FIG. 5), which may be defined as an OFDM symbol offset for time-based repetition, a subcarrier offset for frequency repetition, and/or both an OFDM symbol offset and a subcarrier offset for hybrid repetition. The offset may be measured, for example, with respect to an OFDM symbol (e.g., the first OFDM symbol) and/or a sub-carrier (e.g., the first sub-carrier) of the CCA sub-grid.

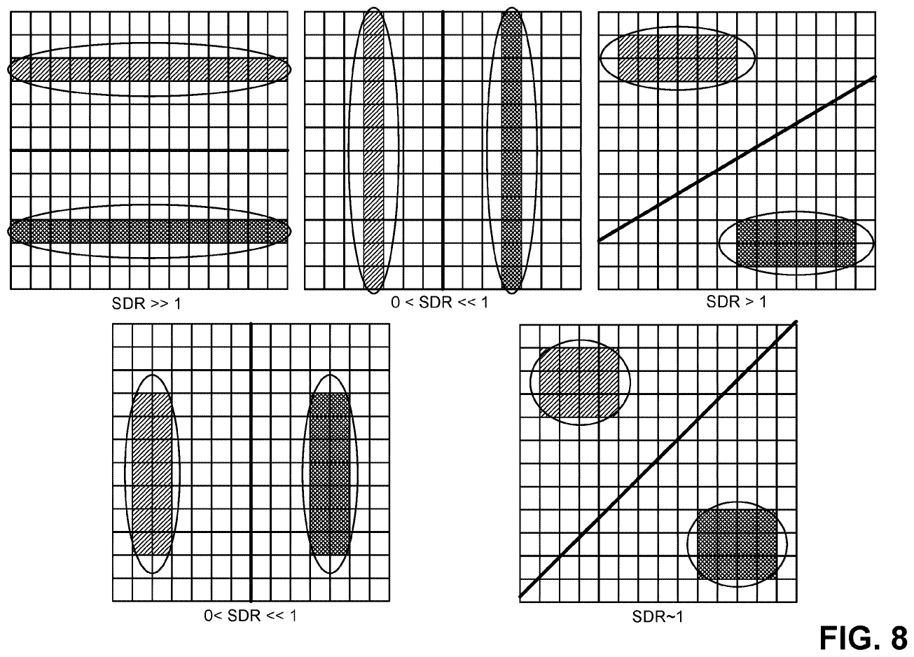

The WTRU may determine a CCA view format, for example, based on one or more channel measurements. For example, a combination of the delay spread and Doppler may be utilized for identifying the CCA views (e.g., shown by REs modeled as ellipses in FIG. 8) and the repetition boundary (e.g., shown by the lines between the REs modeled as ellipses in FIG. 8). The ratio of Delay Spread and/or the Doppler parameters of the channel may be evaluated and/or their ratio (e.g., Delay Spread to Doppler ratio (SDR)) may be utilized for selecting the CCA view format. FIG. 8 shows example configurations for CCA views for a corresponding range of SDR values.

FIG. 8 illustrates example configurations/formats for CCA views with example ranges of values for the delay spread to Doppler ratio (SDR).

A CCA view format may be determined, for example, based on one or more machine learning strategies (e.g., as an alternative or addition to utilizing prior knowledge about channel properties that may influence the CCA view format). One or multiple available channel properties may be utilized. An ML model may learn a relationship (e.g., appropriate relationship) between the channel properties and the CCA formats/configurations.

A WTRU may transmit the associated channel properties and/or rely on the gNB and WTRU to (e.g., independently) estimate the same CCA view formats, for example, depending on the channel properties used and/or the quantization/precision used for representing the (e.g., each of the) channel properties. The WTRU may select the (e.g., suitable) configuration and/or format of the CCA views and/or signal the configuration/format of the CCA views to the gNB, for example, if the number of bits used for transmitting the channel properties is high.

The CCA view selection may (e.g., also) be modeled as a deep learning (DL) problem. For example, a DL model may predict CCA view formats for a (e.g., an entire) channel matrix H. A format prediction may be modeled as a classification problem and/or a segmentation problem. In some examples (e.g., in a classification setting), multiple sets of potential configurations/formats for the CCA views may be (e.g., considered to be) known apriori as a codebook. The DL model may be tasked to predict the configuration/format that may be most suitable for the input channel. In some examples (e.g., in a segmentation setting), the model may produce an output having the same size as the input channel. The model may predict labels for an (e.g., each) RE, for example, to identify whether the RE contributes to view 1, view 2, or neither.

Machine learning approaches described (e.g., as described herein) may (e.g., also) be utilized for one or more other objectives (e.g., as described herein with respect to optimization).

CCA views may be reported. CCA views (e.g., evaluated using the ML and/or the optimization strategies) may be reported, for example, in one or more of the following forms.

CCA views may be reported based on a fixed set and/or a codebook of (e.g., potential) CCA views formats/configurations that may be maintained. A codebook may be known apriori at the WTRU and/or the network (e.g., gNB). A WTRU may (e.g., using ML and/or optimization strategies, such as described herein), identify an (e.g., optimal) view format from the pre-selected formats/configurations. The WTRU may signal the codebook index corresponding to the selected CCA view format.

CCA views may be reported based on modelling as ellipses. For example, two CCA views may be modeled as ellipses (e.g., as shown in FIG. 8 by the bounding ellipse around the reserved REs). An ellipse may be (e.g., fully) characterized as four (4) parameters, which may be given by center coordinates (x1,y1) and axis lengths (a,b). The four (4) quantities may be reported to uniquely define a CCA view. For example, a CCA view may be defined in accordance with Eq. (3):

$$\frac{{( x - x 1 )}^{2}}{{a}^{2}} + \frac{{( y - y 1 )}^{2}}{{b}^{2}} = 1 \qquad ( 3 )$$

CCA views may be reported based on unconstrained CCA view selection (e.g., carried out in a completely unconstrained setting). The REs (e.g., all the Res) contributing to a CCA view may be spread out (e.g., across the entire grid of available Res). The locations of the REs may be (e.g., explicitly) sent from the WTRU to the network (e.g., gNB). The locations of the REs within the view may be sent, for example, (e.g., directly) in an uncompressed form and/or using one or more forms of compression.

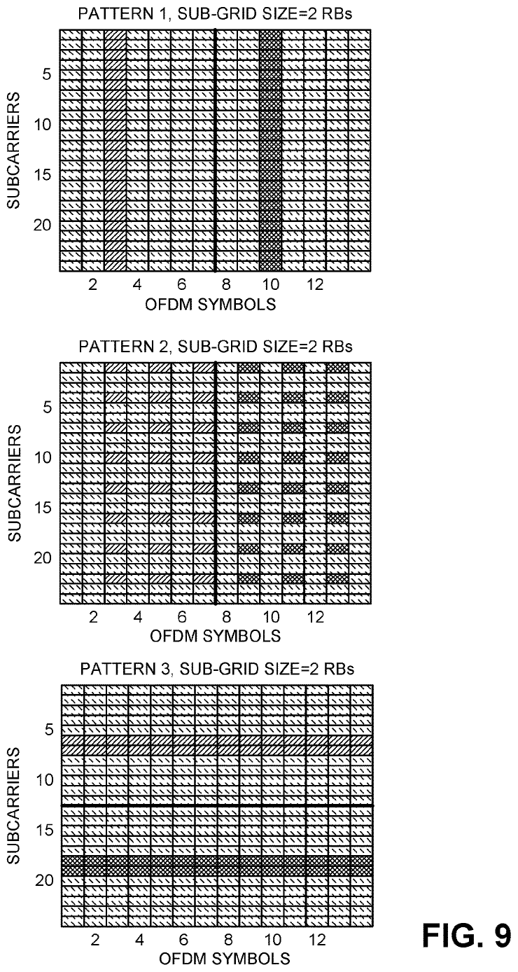

The impact of different CCA view configurations (e.g., using different repetition types) on the symbol error rate (SER) may be indicated (e.g., using simulations) for one or more (e.g., various) channel conditions, such as frequency selective channels (e.g., high delay spread) and/or fast fading channels. FIG. 9 shows examples of CCA view configurations. As shown by example in FIG. 9, Pattern 1 may employ time domain repetition, Pattern 3 may employ frequency domain repetition, and Pattern 2 may be a hybrid.

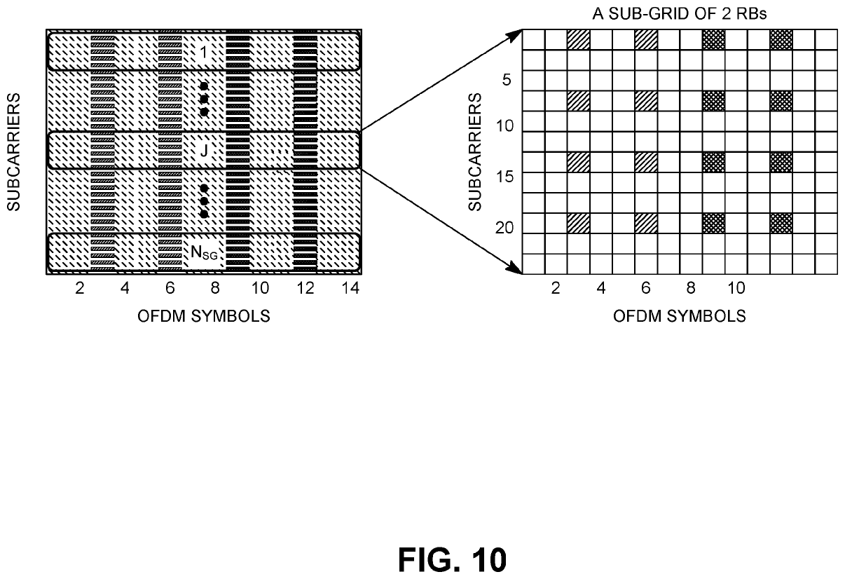

FIG. 9 illustrates examples of CCA view configurations (e.g., repetition type) for performance evaluation. FIG. 10 illustrates example CCA sub-grids and CCA views per sub-grid.

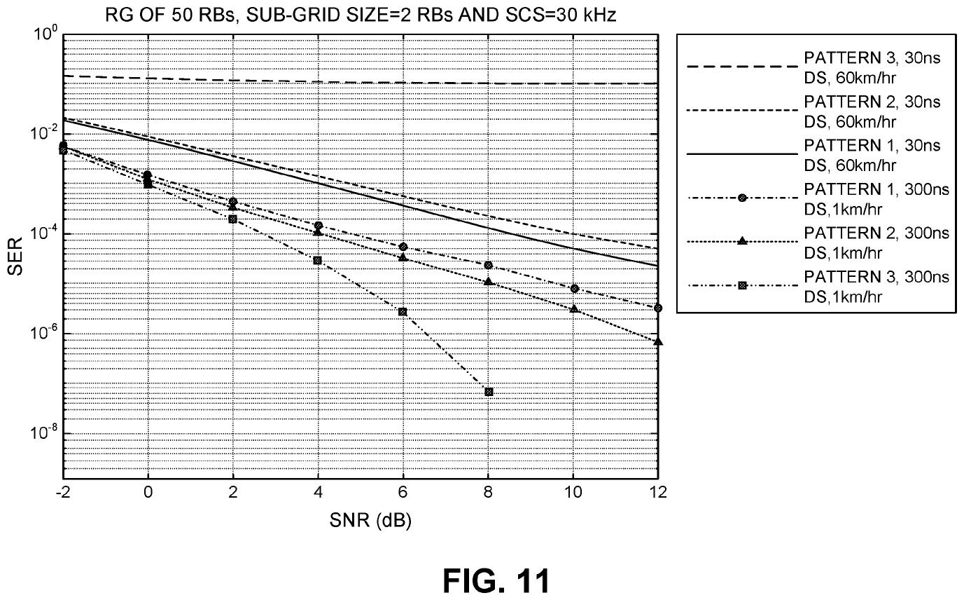

FIG. 11 shows examples of the symbol error rate (SER) for the example CCA repetition patterns shown in FIG. 9. FIG. 11 shows that Pattern 3 may perform better than Pattern 1 and/or Pattern 2, for example, in a high delay spread and/or low Doppler scenario. FIG. 11 shows that Pattern 1 may perform better than Pattern 2 and/or Pattern 3 (e.g., with Pattern 3 failing), for example, in a low delay spread and/or high Doppler scenario. The example SER results for the example CCA repetition patterns may indicate/suggest that the repetition type and/or pattern choice may be important (e.g., crucial) to optimize CCA performance.

FIG. 11 illustrates example SER results (e.g., simulation results) for different CCA view configurations (e.g., different repetition types) in frequency selective and/or fast fading channels.

CCA view length may be determined.

CCA view length (N) is a (e.g., critical) parameter that may be (e.g., carefully) chosen. CCA view length may be referred to as the repetition pattern density. Increasing N (e.g., to a higher value of N) may improve CCA performance, but may (e.g., at the same time) reduce and/or throttle the transmission rate, which may reduce the maximum achievable throughput, for example, since more reserved/redundant REs may be used for repetition.

A WTRU may (e.g., be configured to) determine and/or report CCA view length. For example, a WTRU may determine a preferred view length based on the PDSCH performance, e.g., by tracking the BLER performance. The WTRU may indicate to increase the CCA view length, for example, if the BLER exceeds a (pre)configured BLER threshold (γ_{BELR}). A WTRU may determine the view length, for example, based on the available computation resources, receiver complexity, and/or communication latency. Higher N may increase the number of multiplications that may be used to construct the auto- and/or cross-covariance matrices that may be used in deriving the CCA combiners. Higher N may (e.g., thus) impact the receiver complexity. In some examples, a WTRU may determine the view length based on a preconfigured CCA correlation coefficient threshold (ρₜₕ), e.g., as described herein. Increasing N may result in an improvement in the CCA correlation coefficient, which may (e.g., in turn) imply better CCA performance. The WTRU may recommend a (e.g., preferred) value of N, for example, by tracking the correlation coefficient, which may be compared with the (pre)configured threshold. For example, a WTRU may indicate to a network (e.g., gNB) to reduce, increase or fix N based on the measured correlation. A WTRU may send an indication to reduce N, for example, if the measured ρ is higher than ρₜₕ. A WTRU may send an indication to increase N, for example, if the measured ρ is smaller than ρₜₕ. The WTRU may send nothing, for example, if the measured ρ is equal to or close to ρₜₕ up to ϵ.

A WTRU may (e.g., be configured to) solve one or multiple CCA problems independently. A (e.g., one) CCA problem may be solved for each CCA sub-grid (e.g., as described/defined herein). Channel conditions across different sub-grids may (e.g., naturally) be different. A CCA may (e.g., accordingly) behave differently for a (e.g., each) CCA sub-grid. A WTRU may (e.g., be configured to) report a (e.g., preferred) CCA view length for a (e.g., each) CCA sub-grid, for example, based on the measured CCA correlation coefficient for a (e.g., each) sub-grid. A WTRU may receive configuration information indicating (e.g., be configured with) a set of possible values of view lengths, for example, to reduce the associated uplink overhead. The WTRU may recommend one or more of the available values.

A WTRU (e.g., supporting multilayer transmission) may determine and/or report a (e.g., preferred) CCA view length for a (e.g., each) layer (e.g., independently). For example, a WTRU may measure the received SNR associated with each layer. The WTRU may determine the per-layer view length for each layer, for example, according to the measured SNR.

CCA view length may be determined based on numerical results. The impact of CCA view length performance may be evaluated, for example, via simulations.

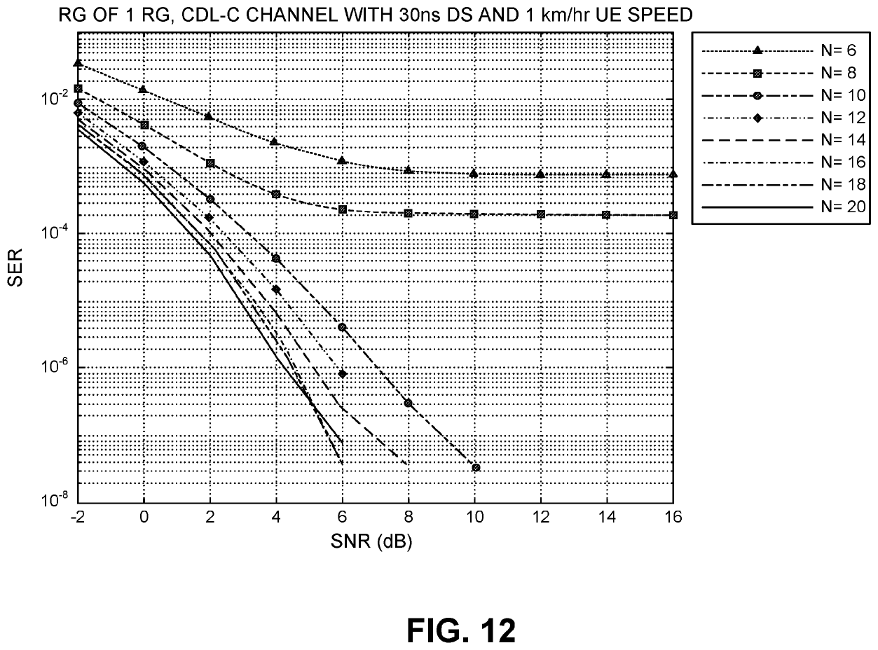

FIG. 12 shows an example plot of SER versus the received SNR for different values of N, where 6≤N≤20. Increasing the view length may improve the average SER performance, e.g., up to a value of N. As shown in FIG. 12, the improvement may be (e.g., only) a slight improvement in the SER, for example, if/when N exceeds 14.

FIG. 12 illustrates an example of CCA performance for different view lengths 6≤N≤20.

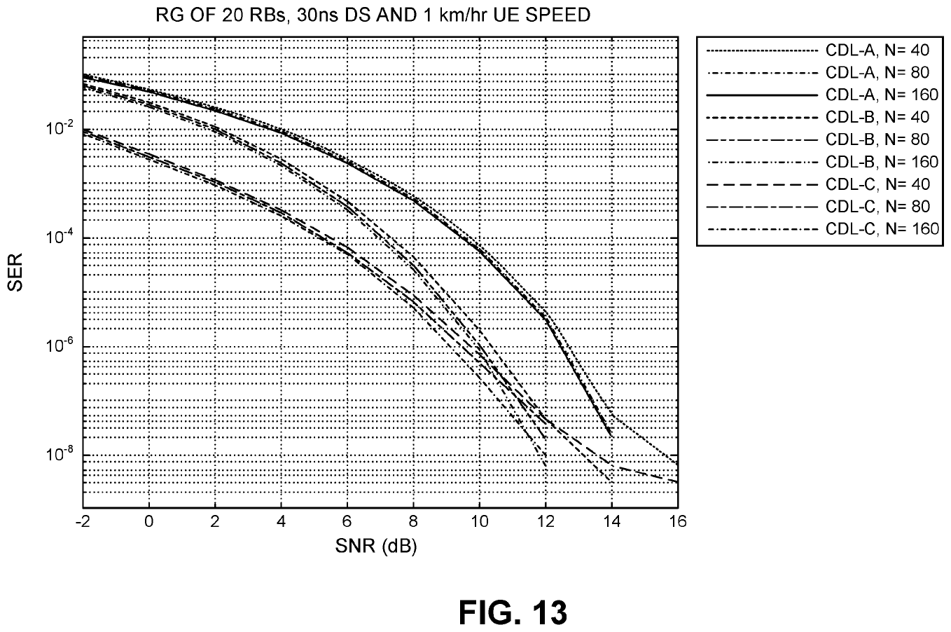

Large values of N (e.g., significantly large values of N) may reduce the overall transmission rate (e.g., as the number of non-data REs increases), for example, without boosting the detection accuracy. FIG. 13 shows an example of results (e.g., simulation results) for a higher range of N, 40≤N≤160, under various channel models identified in FIG. 13.

FIG. 13 illustrates examples of CCA performance for different view lengths 40≤N≤160.

FIG. 13 shows (e.g., consistent with other findings described herein) that large values of N may not (e.g., significantly) enhance performance. The trade-off between the view length and the transmission rate may be taken into consideration.

CCA performance may be optimized in frequency selective channels (e.g., by sub-gridding). Sub-gridding may be used to optimize CCA performance, for example, in (e.g., highly) frequency selective channels scenarios. Sub-gridding may be inspired by RB bundling (e.g., to mitigate the effect of frequency selectivity). Sub-gridding may be different from the sub-band concept used for deriving the PMI as part of the CSI report. Sub-gridding may be used to determine the number of CCA problems to solve to maintain a target performance. Sub-gridding may involve the WTRU slicing the allocated BWP (e.g., the entire resource grid) into multiple sub-grids (e.g., referred to as CCA sub-grids). A WTRU may divide the (e.g., entire) resource grid into disjointed/non-overlapping and/or partially overlapping sub-grids. The CCA-based equalization may be performed (e.g., independently) for each CCA sub-grid. Sub-grids may allow the CCA combiners to be (e.g., designed/implemented) based on (e.g., roughly) flat channels. More than two combiners may be used across the resource grid, which may allow for a better interpolation/extrapolation for optimal equalization for the different REs. The number of CCA-RS that may be used for scaling ambiguity resolution may be assigned for each sub-grid, for example, since each sub-grid may involve solving a (e.g., one) CCA problem. The number of CCA-RS may be configured per sub-grid. The WTRU may determine and/or report the number of CCA sub-grids and/or the sub-grid size(s) for (e.g., to meet) a target performance.

A WTRU may determine one or more sub-gridding parameters (e.g., sub-grid information). A WTRU may derive one or more sub-gridding parameters (e.g., number of CCA sub-grids, size of each CCA sub-grid, and/or number of CCA-RS per sub-grid), for example, based on (e.g., full) channel state information measurements, a CCA correlation coefficient (e.g., and CCA views), and/or computational complexity.

In some examples, a WTRU may (e.g., be configured to) determine one or more sub-gridding parameters (e.g., sub-grid information), which may include the number of sub-grids (N_{GS}) and/or the sub-grid size (SGS). A WTRU may determine a CCA sub-grid size (e.g., measured in number of RBs), for example, as a function of the CCA correlation coefficient f(ρ) (e.g., and based on CCA views). The CCA correlation coefficient f(ρ) may be determined/chosen (e.g., based on CCA view(s), such as, for example, a first CCA view and a second CCA view), for example, in accordance with Eq. (4):

$$f ( ρ ) = {\sum }_{i = 1}^{{N}_{SG}} {α}_{i} {ρ}_{i} \qquad ( 4 )$$

With reference to Eq. (4), coefficients αᵢ and ρᵢ may, respectively, represent the weight and correlation coefficient associated with sub-grid i A WTRU may determine N_{SG} and SGS, for example, by comparing f(p) with a (pre)configured correlation coefficient. For example, a WTRU may find an SGS that results in a measured correlation coefficient close to a preconfigured CCA correlation coefficient threshold γₜₕ.

In some examples, a WTRU may determine sub-gridding parameters (N_{SG}, SGS) as a function of (e.g., full) CSI measurements (e.g., the WTRU may receive a CSI-RS and may perform a measurement associated with the CSI-RS where, for example, the CCA sub-grid information my be determined based on the measurement). For example, a WTRU determine the SGS by using the channel matrices, Hⱼ, for j=1, . . . , SGS, which may be estimated via CSI-RS. The WTRU may compute f(Hⱼ) for an SGS and/or a preconfigured CCASCIerror parameter. The function f(Hⱼ) may be determined/chosen as the mean square error (MSE), for example, in accordance with Eq. (5):

$$f ( {H}_{j} ) = {\sum }_{j < k} {‖ {H}_{j} - {H}_{k} ‖}_{F}^{2} \qquad ( 5 )$$

With reference to Eq. (5), ∥.∥_{F} may denote the Frobenius norm. A WTRU may adapt the SGS until an MSE condition is met, e.g., based on the preconfigured CCACSIerror. In some examples, f(Hⱼ) may be adopted to be the sum or weighted sum cosine similarity.

A WTRU may (e.g., be configured to) determine the number of CCA-RS symbols, for example, based on the measured SNR per sub-grid and/or one or more reference signals (e.g., reference signal related measurements, such as RSRP and/or RSRQ). A WTRU may receive configuration information indicating (e.g., be configured with) a mapping between the number of CCA-RS and the associated SNR thresholds. A higher SNR may involve fewer CCA-RSs, for example, relative to the low SNR region (e.g., as described herein). The CCA-RS locations (e.g., with respect to the start of a subgrid) may be (pre) defined at the network (e.g., gNB) and/or the WTRU.

A WTRU (e.g., configured for CCA processing and/or employing sub-gridding) may (e.g., also) determine and/or report the CCA-RBoffset parameter to the gNB. The CCA-RBoffset may be a value or number that defines the periodicity of the repetition of a CCA pattern across RBs. For example, CCA-RBoffset=1 RB may indicate that a CCA pattern is repeated in every RB while CCA-RBoffset=2 RBs may indicate that the repetition is performed in every other RB, e.g., RBs 1, 3, 5, . . . , etc. The parameter CCA-RBoffset may help improve the transmission rate, for example, since a smaller number of reserved REs may be used if (e.g., when) CCA-RBoffset is greater than one. A WTRU may (e.g., if configured) determine the CCA-RBoffset parameter, for example, based on (e.g., full) CSI measurements (e.g., by measuring the variations in the channel across the different RBs). The WTRU may select or choose the CCA-RBoffset that satisfies a preconfigured MSE threshold. A WTRU may satisfy one or more conditions, for example, if (e.g., when) determining the value of CCA-RBoffset for time repetition patterns. For example, a condition (e.g., for a time repetition pattern) may be 1≤CCARBoffset≤subgrid size. A WTRU may satisfy one or more conditions, for example, if (e.g., when) determining the value of CCA-RBoffset for frequency repetition patterns. For example, a condition (e.g., for a frequency repetition pattern) may be

$$1 \leq CCARBoffset \leq \frac{subgrid size}{2} .$$

The conditions may ensure that (e.g., all) the sub-grids have CCA symbols to construct the combiners. A WTRU may assume a default, for example, if the field is not indicated/missing. For example, the WTRU may assume that CCA-RBoffset=1 RB if the field is not indicated.

The network (e.g., gNB) may send configuration information indicating (e.g., providing a configuration for) the CCA-RS and/or the CCA parameters (e.g., configured CCA parameters, such as, for example, a configured sub-band size), e.g., the CCA pattern per sub-grid. The WTRU may report sub-gridding information to the gNB, for example, to enable the gNB to generate the configuration. The sub-gridding information may be a sequence of sub-grids' starting points in the resource grid. Uplink signaling overhead may be decreased or minimized. For example, a WTRU may report a single integer value defining the sub-grid size, e.g., if/when equal-sized and non-overlapping sub-grids are configured for CCA equalization.

Sub-gridding parameters may be determined based on numerical results.

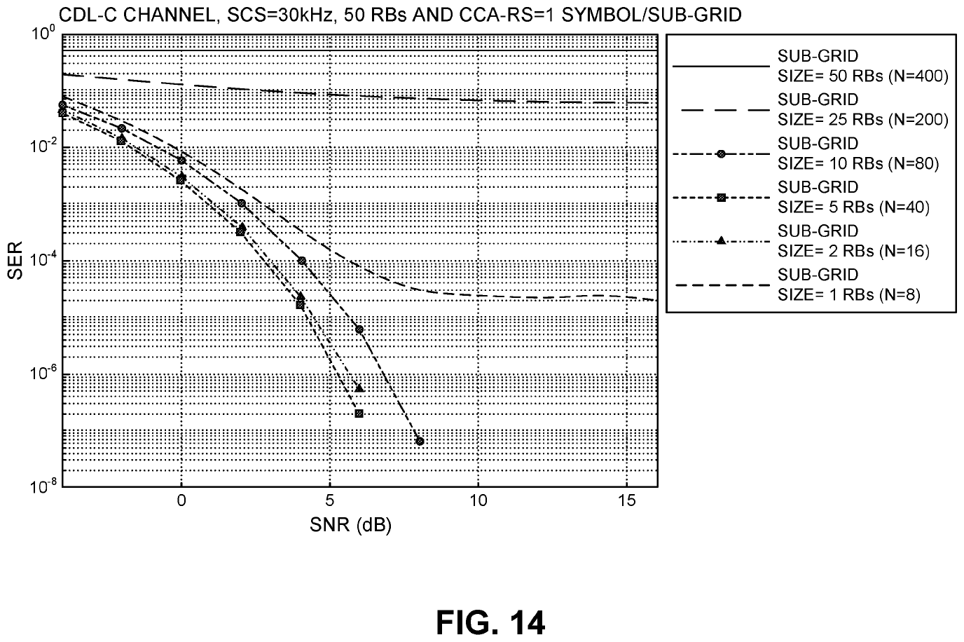

FIG. 14 shows examples of SER results (e.g., simulation results) for various sub-grid sizes of 1 to 50 RBs in (e.g., highly) frequency selective channels (e.g., where channel coherence BW<<signal BW). As indicated in FIG. 14, the example results are shown for a CDL-C channel with a 30 ns delay spread, a WTRU velocity of 1 km/hour, with equal-sized and non-overlapping sub-grids.

FIG. 14 illustrates example SER results for equal and non-overlapping sub-grids in a CDL-C channel with delay spread of 30 ns and a WTRU velocity of 1 km/hour.

Example SER results indicate that CCA performance may degrade for large sub-grid sizes, e.g., sub-grids of sizes 50 and 25 RBs. Performance degradation may occur because the symbols within a CCA signal experience different channel response, which may violate a condition that the symbols within a CCA should be constructed, and/or repeated, within a time-bandwidth coherence block. The SER may decrease based on a decrease in the sub-grid size (e.g., to sub-grids of sizes 10, 5, and/or 2 RBs), for example, as the channel affecting the CCA signal within each sub-grid tends to be flatter. The (e.g., average) SER may degrade if (e.g., when) the sub-grid size is 1 RB, for example, because the view length per sub-grid tends to be too (e.g., significantly) small.

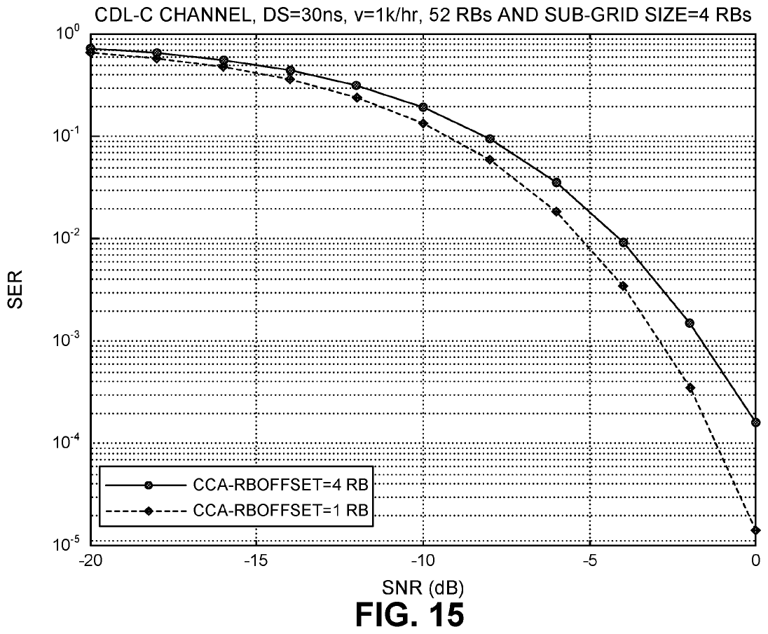

FIG. 15 shows example SER results (e.g., simulation results) for an average SER for a CCA pattern with 12 reserved REs/RB and different CCA-RBoffset values. CCA-RB offset may increase the transmission data rate, for example, as a smaller number of reserved REs is needed. A WTRU may (e.g., then) implement one or more methods (e.g., as described herein) to aid the decision of the proper CCA-RBoffset value to be reported to (e.g., and used by), the gNB.

FIG. 15 illustrates an example plot of SER versus SNR for data transmitted over a CDL-C channel and a resource grid of 52 RBs with sub-grid size of 4 RBs.

Sub-gridding may be based on (e.g., have a relationship with) sub-band size.

A WTRU (e.g., configured for CCA processing and/or employing sub-gridding) may consider that the CCA symbols within a view may be precoded with the same precoder, e.g., according to a preconfigured sub-band size. Different CCA views may be precoded using different precoders, e.g., CCA patterns that utilize a frequency repetition structure and/or each of the views lies within a different sub-band. Symbols within a view may be precoded using the same precoder, e.g., CCA patterns that are repeated in time and/or where symbols in each view span (e.g., all) the resource blocks within the sub-grid.

A WTRU may (e.g., therefore) determine the sub-grid size based on the configured sub-band size (e.g., PRG size). A WTRU may prevent differently precoded symbols within a CCA view, for example, by (e.g., first) determining the sub-grid size. The sub-grid size may be determined, for example, such that one or more conditions are satisfied for a time repetition scheme. For example, a condition (e.g., for a time repetition scheme) may be mod (B, subgrid size)=0. The sub-grid size may be determined, for example, such that one or more conditions are satisfied for a frequency repetition of one. For example, a condition (e.g., for a frequency repetition scheme) may be

$$mod ( B , \frac{subgrid size}{2} ) = 0 ,$$

e.g., since a CCA view in a frequency repetition scheme may be collected from half the sub-grid.

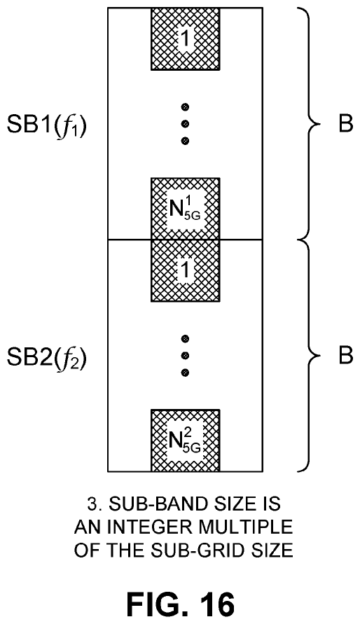

FIG. 16 illustrates an example of a sub-grid and sub-band size relation, where REs within sub-band SBn may be pre-coded with the precoder fₙ.

Sub-gridding may be based on a numerical result.

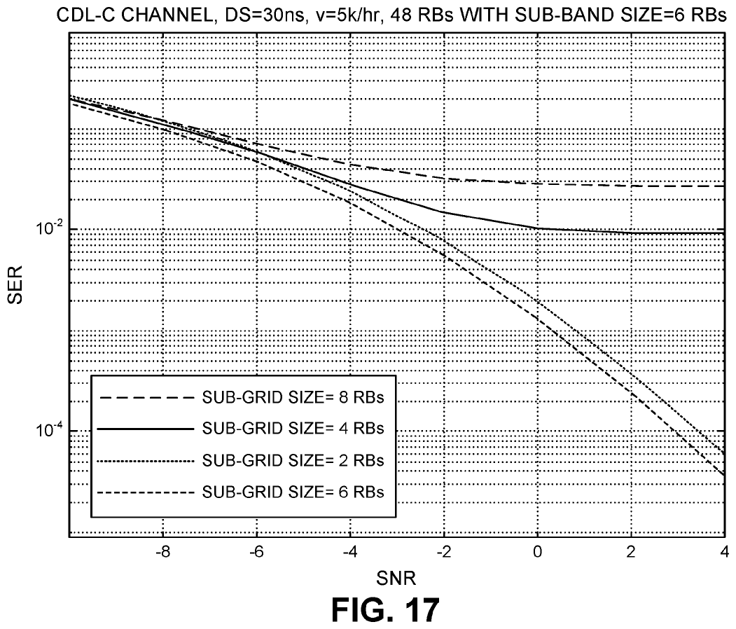

FIG. 17 shows an example plot of SER versus SNR results (e.g., simulation results) for a time repetition scheme in a resource grid of 48 RBs and sub-band size of 6 RBs. Sub-grid sizes that do not satisfy a condition (e.g., for a time repetition scheme) may fail to recover the transmitted symbols.

FIG. 17 illustrates an example plot of SER versus SNR for different sub-grid sizes in a resource grid of 48 RBs and sub-band size of 6 RBs.

Phase ambiguity may be resolved.

A CCA procedure may produce symbol estimates with a scaling error (e.g., an unknown complex scaling error), which may result in a rotated and/or scaled constellation. For example, the points in the observed constellation may be rotated and/or scaled (e.g., by the same amount) with respect to the reference constellation, e.g., after application of the CCA combiner(s). The phase error may be estimated and/or corrected, for example, by using a subset of the REs used in the views to carry CCA pilot symbols (e.g., symbols with known phase), which may be referred to as CCA-RS. CCA-RS symbols may be incorporated into the CCA views. For example, N_{CCA-RS} symbols may be used to carry pilots for a view defined as a sequence of symbol (RE) indices In={1:N}. The N_{CCA-RS} of the N REs in the view may not be available for carrying data symbols, e.g., because they may (e.g., instead) carry known pilot symbols. IPn, n={1:N_{CCA-RS}} may be the indices used for pilots in the first view. The indices used for pilots {IPn} may be a subset of {In}. The same set of indices (e.g., with an offset by the distance between views) may be used in the second view. The view may (e.g., in this way) maintain the property of being a repetition up to a (e.g., any) phase difference (e.g., introduced by the CCA-RS(s)). REs (e.g., the same REs) in a (e.g., each) view may be used to carry the CCA pilots. The pilots may be known. An (e.g., each) RE carrying a pilot may be de-rotated, for example, by the known phase of the pilot (e.g., prior to further processing). The REs used to carry pilots may (e.g., in this way also) contribute to the estimation of the CCA combiners.

A WTRU may determine a (e.g., preferred) number, N_{CCA-RS}, of pilots used in the views and/or how the pilots may be distributed within the view. In some examples, (e.g., only) the preferred Np may be determined and/or reported to the network. The (e.g., exact) location of the pilots within the view may be determined by a (e.g., an agreed) relationship between the view parameters and N_{CCA-RS}. For example, the first Np REs in the view may be used for CCA pilots. In some examples, IPn=Im, m=1, floor (N*n/N_{CCA-RS}), . . . N, n=1, . . . , N_{CCA-RS}; e.g., the pilots may be interleaved over the view, which may reduce exposure to narrowband interference.

In some examples, a WTRU may (e.g., also) determine and/or report how the CCA pilots may be distributed within the view. For example, a WTRU may determine and/or report the number N_{CCA-RS} and/or a starting index within the view (e.g., the start location and/or length of consecutive REs may be reported).

A WTRU may determine whether a single-phase correction is applied to a whole subgroup or whether multiple phase corrections may be applied across the TTI, for example, based on estimated channel properties (e.g., coherence time, SNR, and/or the locations of the pilots). A separate phase correction may be computed for a (e.g., each) CCA combiner, for example, if the coherence time is estimated to be small and/or if the views are separated by one or more OFDM symbols. The phase correction estimates from the (e.g., two) views may be interpolated and/or extrapolated, for example, to provide separate phase corrections to one or more (e.g., each) of the OFDM symbols in the TTI.

A composite channel may be composed on the propagation channel, precoding, antennas, and/or radio impairments. The radio impairments may contribute to the dynamics of the channel, for example, in a way that may not be correlated to the propagation channel. Phase noise may make the coherence time of the composite channel short, for example, even if the propagation channel itself is stationary. Short coherence time may occur for higher carrier frequencies (e.g., FR2). Coherence time may be improved, for example, by PTRS pilots. PTRS may be dense in the time domain and/or sparse in the frequency domain. In some examples, there may be up to one (1) subcarrier for PTRS every other RB in the frequency domain. In some examples, there may be a PTRS every symbol in the time domain (e.g., except where DMRS is located).

PTRS may be used in low phase noise. PTRS may be used in FR2 and/or configured for use in FR1. One or more (e.g., some or all) of the PTRS within a subgroup may be used for CCA phase estimation and/or correction, e.g., alone or in combination with the N_{CCA-RS} pilots introduced into the views. The (e.g., existing) PTRS parameters may be used, for example, if (e.g., when) CCA views are used, but the procedures for interpreting them for locating the PTRS REs may be different. The locations of REs in the views may be treated similarly to DMRS for the purpose of determining PTRS location (e.g., PTRS adapts to CCA views in a similar way that PTRS adapts to DMRS), for example, if (e.g., when) PTRS is configured with CCA. The PT-RS symbol locations in a slot may start from the first OFDM symbol in the shared channel allocation and/or may hop every LPT-RS symbols, for example, if a DM-RS symbol is not present in the interval and/or if the PTRS RE may intersect with an RE from a view. In some examples, DMRS and CCA views may be used simultaneously.

In some examples (e.g., if the PTRS RE may intersect with a RE from a CCA view), the PTRS may be inserted in the view (e.g., and the RE may not be used to carry a data symbol) and/or the corresponding RE in the other view may (e.g., also) be populated with a PTRS RE.

The symbols carried in the CCA views may be (e.g., inherently) more robust, for example, due to repetition (e.g., they can be combined). For example, more coded bits may be packed into the views to accommodate overhead from PTRS and/or N_{CCA-RS} pilots. In some examples (e.g., if/when a PTRS RE(s) is populated into the CCA views, as described herein), the transport block size may be maintained at its original size after insertion of PTRS into the CCA views, e.g., by increasing the modulation order of other REs in the views. For example, 16QAM may be used and multiple (e.g., three (3) PTRS REs may be inserted into the views, in which case 4×3=12 coded bits may be lost. Compensation may be implemented, for example, by modulating six (6) of the remaining REs in each CCA view with 64QAM (e.g., an increase of 6*2=12 bits in the view) to maintain the same coded block size (e.g., after PTRS is added). Similarly, PTRS may be inserted into a (e.g., another) part of the allocation (e.g., not part of the CCA view). The lost coded bits may be (e.g., similarly) packed into the CCA view, e.g., using higher order modulation. Similarly, N_{CCA-RS} pilots may be included in the CCA views. The lost coded bits may be (e.g., similarly) packed into the CCA view, e.g., using higher order modulation.

PTRS may be used in high phase noise. PTRS may be used, for example, if (e.g., when) the phase noise is large. PTRS may be used with higher time domain density (e.g., as dense as every symbol), for example, along with CCA views to provide additional benefit, e.g., if (e.g., when) phase noise is large. CCA views may include Np>0 pilots (e.g., in addition to PTRS pilots) and/or N_{CCA-RS} may be zero. One or more (e.g., some or all) of the PTRS REs may be used, e.g., along with the Np CCA pilots, for phase estimation and/or correction. PTRS REs may be used to better interpolate the CCA combiners in OFDM symbol that may not include a CCA view. For example, CCA views in symbols 2 and 12 may (e.g., normally) be interpolated without the aid of PTRS in FR1, e.g., since the variation from one CCA combiner to the next may be due to the propagation channel dynamics. In some examples (e.g., for FR1), two OFDM symbols for pilots may be sufficient to track channel variations for demodulation purposes. In some examples (e.g., in high velocity channel, which may be induced by phase noise impairments), the interpolation of the CCA combiners may be improved through high time-domain density PTRS. For example, CCA combiners may be interpolated/extrapolated normally (e.g., without aid of PTRS). The interpolated/extrapolated CCA combiners may be based on the (e.g., two) base combiners produced by CCA. The interpolated/extrapolated CCA combiners may include phase and/or amplitude adjustments. The interpolated/extrapolated CCA combiners may be (e.g., fundamentally) limited to slow variations within the TTI, for example, since there may be (e.g., only two) time domain observations of the channel. The interpolated/extrapolated CCA combiners may be (e.g., further) adjusted, for example, to correct phase variations that may be visible to the high density PTRS and/or not visible to the lower density CCA views. The adjustments may be (e.g., only) phase adjustments. The adjustments may be the same for (e.g., all) allocated REs in a corresponding OFDM symbol. The combiner phase in an (e.g., each) OFDM symbol may be adjusted by the normalized (e.g., and/or filtered) phase estimates of/from the PTRS RE. The normalization may be implemented with respect to the OFDM symbols in which the CCA view exists, e.g., so that the phase adjustment due to PTRS may be zero in the OFDM symbols.

CCA parameters may be determined based on numerical results.

Link-level performance of CCA equalization may be compared to a (e.g., legacy) DM-RS based approach. In some examples (e.g., for DMRS), least square (LS) estimation may be employed to calculate the effective channel at the DMRS symbol locations, which may be followed by time/frequency interpolation and/or extrapolation for an estimate in the remaining REs. Minimum mean square error (MMSE) equalization may be performed, for example, for an effective channel estimate and/or the received signal. The received PDSCH data may be demodulated (e.g., for CCA and DMRS). PDSCH channel processing (e.g., full PDSCH channel processing) may be performed (e.g., for CCA and DMRS). Perfect channel (PCHAN) knowledge results may be incorporated, for example, as an upper bound on the BER and/or throughput performances.

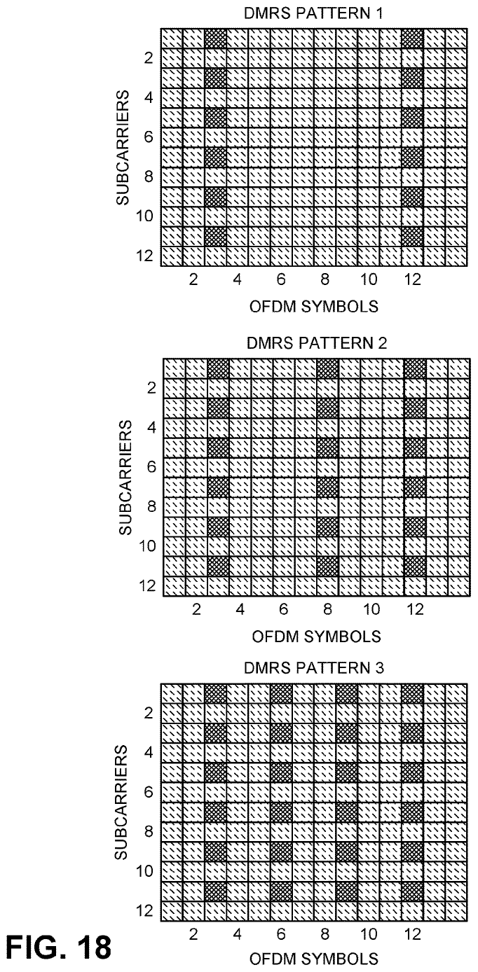

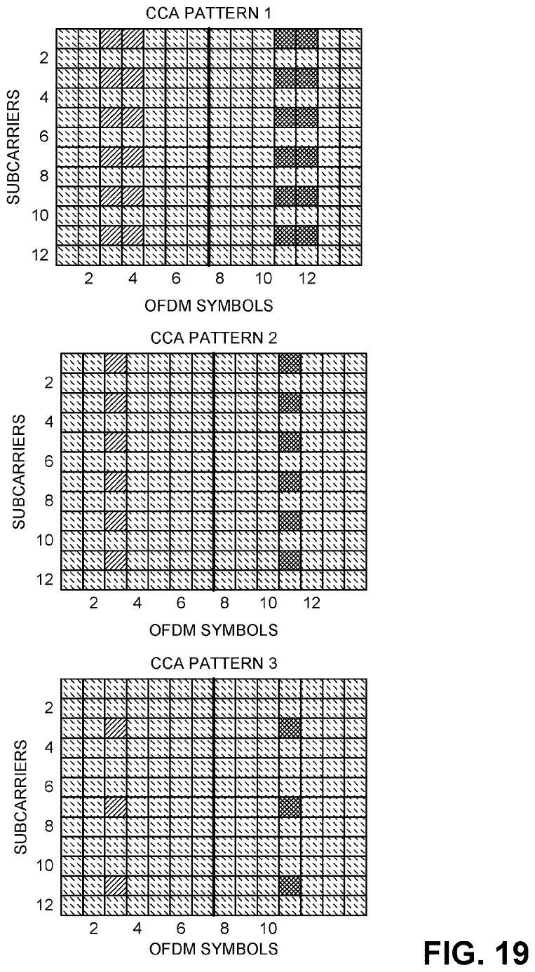

DMRS patterns in FIG. 18 may be compared with CCA patterns in FIG. 19.

FIG. 18 illustrates examples of DM-RS patterns.

FIG. 19 illustrates examples of CCA patterns. The red lines (e.g., middle vertical lines) shown in the examples separate the groups of REs combined with the same combiner.

Link level performance may be determined for a low delay spread and a high speed WTRU. Link level (e.g., simulation) results for a low-delay spread and high WTRU speed may be generated, for example, using a CDL-C channel model with a delay spread of 30 ns and a WTRU speed of 60 km/hr.

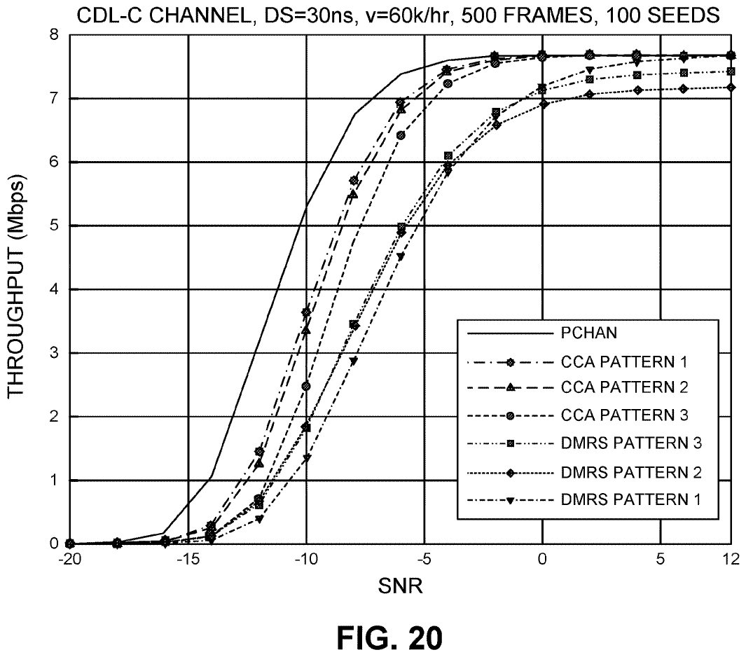

FIG. 20 shows examples of throughput results for CCA and (e.g., legacy) DM-RS based approaches. As shown in FIG. 20, CCA patterns may provide (e.g., on average) 40% more throughput than DMRS patterns. The maximum achievable throughput by (e.g., all) CCA patterns may be more than the maximum achievable throughput of DMRS patterns 2 and 3, for example, because the number of reserved REs/RB for the CCA patterns may be less than the counterparts for DMRS. CCA patterns may provide a larger transport block size and/or an increased maximum throughput (e.g., compared to DM-RS patterns).

FIG. 20 illustrates examples of CCA and DM-RS based throughput versus SNR for an RG of 52 RBs and a sub-grid size of 4 RBs.

Link level performance may be determined for a high delay spread and a low speed WTRU. Link level simulation results for a high-delay spread and low WTRU speed may be generated, for example, using the CDL-C channel model with a delay spread of 300 ns and a WTRU speed of 1 km/hr.

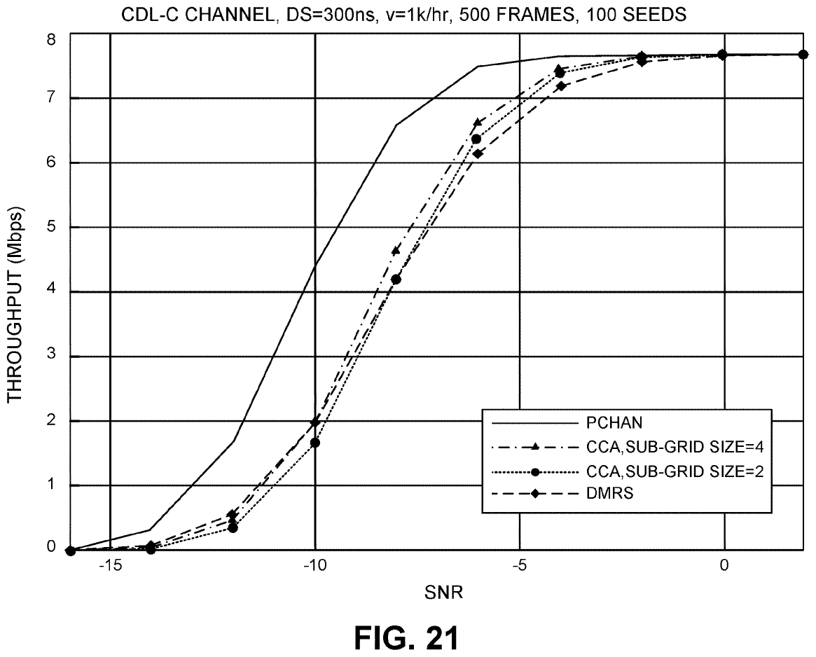

A DMRS pattern (e.g., DMRS pattern 1) may be compared with a CCA pattern (e.g., described in while varying the sub-grid size such that sub-grid size∈{2,4}. FIG. 21 shows that CCA patterns provide higher throughput compared to the considered DMRS.

FIG. 21 illustrates examples of CCA and DM-RS based throughput versus SNR for an RG of 52 RBs.

CCA parameters may be indicated.

CCA view parameters and/or CCA view performance may be reported, for example, based on one or more triggers. A WTRU may determine the CCA view parameters and/or the CCA view performance. The WTRU may be triggered to report CCA view parameters and/or performance.

Triggers to report the CCA view performance may include, for example, one or more of the following: a trigger based on the WTRU detecting a change in the channel conditions, e.g., as measured based on the received CSI-RS; a trigger based on the WTRU determining that the CCA performance is lower than a configured threshold; a trigger based on the WTRU receiving a (e.g., new) CCA view configuration from the gNB; a trigger based on a change in the DL assignment parameters (e.g., the number of allocated PRBs may change and/or or the gNB may change the precoding resource block group (PRG) size; a periodic trigger (e.g., every N received data channel TTIs, where N may be one or more and/or may be configured by a gNB); and/or a trigger based on the WTRU receiving a CCA performance report request from the gNB.

Triggers to report the CCA view parameters may include, for example, one or more of the following: a trigger based on a scheduled transmission of UL CSI reports (e.g., a WTRU may be configured to include one or more parameters of the preferred CCA view configuration determined by the WTRU in a UL CSI report); a trigger based on the WTRU determining a change in the channel conditions, e.g., as measured based on the received CSI-RS; a trigger based on the WTRU determining that the CCA performance is lower than a configured threshold; and/or a periodic trigger (e.g., at time instances configured by a gNB).

CCA view performance may be monitored. A WTRU may measure the performance of a (e.g., current) CCA configuration, for example, based on the received CCA views. In some examples, a WTRU may measure a CCA correlation coefficient for a (e.g., each) CCA sub-grid in assigned data channel resources. In some examples (e.g., if/when a WTRU is configured with more than one CCA sub-grid for assigned resources), the WTRU may calculate a (e.g., an average) CCA correlation coefficient across the sub-views. In some examples, the WTRU may measure the CCA correlation coefficient for one or more (e.g., smaller) CCA sub-grids. For example, a WTRU may measure the CCA correlation coefficient for one or more (e.g., smaller) CCA sub-grids if the measured CCA correlation coefficient for a configured sub-grid is below a configured threshold. A WTRU may measure a CCA correlation coefficient (e.g., per sub-grid or average), for example, for each transmission layer, e.g., if/when multi-layer transmission is used. The WTRU may measure the CCA correlation coefficients during a (e.g., every) TTI where a data channel is received.

In some examples, a WTRU may use data channel ACK/NACK statistics to monitor CCA view performance.

CCA view parameters (e.g., preferred CCA view parameters) may be determined. A WTRU may determine CCA view(s) (e.g., preferred CCA view(s)) (e.g., a first CCA view or second CCA view) and/or a preferred subset of parameters for the CCA view, for example, based on measurements of the received CSI-RS. The WTRU may determine, for example, one or more of the following: a CCA sub-grid size; a number of CCA-RS (e.g., per sub-grid); a CCA view length (e.g., per sub-grid); and/or a repetition type (e.g., RepetitionConfigType), which may indicate whether the selected data RE should be repeated in time, frequency, and/or a hybrid of time and frequency.

In some examples, a WTRU may determine one or more CCA view parameters (e.g., preferred CCA view parameters), for example, based on a current (e.g., received) CCA view. For example, a WTRU may calculate a CCA correlation coefficient for a first sub-grid size smaller than the configured sub-grid. A WTRU may select the first sub-grid size as a (e.g., preferred) CCA view parameter, for example, if the CCA correlation coefficient measured for the first CCA sub-grid is larger than the correlation coefficient for the configured sub-gird.

CCA view parameters (e.g., preferred CCA view parameters) may be reported. A WTRU may report the parameters or a subset of parameters of the determined (e.g., preferred) CCA view configuration. In some examples, a WTRU may report the full set of parameters of the determined (e.g., preferred) CCA view. In some examples, a WTRU may report a subset of parameters of the (e.g., preferred) CCA view that are different from the configured CCA view. For example, the WTRU may report the (e.g., preferred) CCA sub-grid size, if/when the (e.g., preferred) CCA sub-grid size is different from the PRG size.

A WTRU may use dedicated UL resources to report (e.g., preferred) CCA view parameters.

A fallback to legacy determination may be made.

A WTRU may perform measurements for detection of error events. A WTRU (e.g., configured for CCA based data channel processing) may perform measurements to monitor equalization performance. Measurements performed by a WTRU may include, for example, one or more of the following: a CCA correlation coefficient (e.g., associated with a first CCA view and a second CCA view); one or more channel conditions (e.g., delay spread, Doppler); a received SNR and/or RSRP; and/or HARQ ACK statistics.

A WTRU may measure a CCA correlation coefficient for a (e.g., each) slot where a data channel transmission is enabled. A WTRU may (e.g., alternatively) measure a CCA correlation coefficient at configured time instances (e.g., slots, frames) during data channel transmissions.

A WTRU may be configured with one or more thresholds, e.g., via RRC signaling. For example, a threshold may be a CCA correlation threshold. A CCA correlation threshold may be fixed or may be a function of SNR. A WTRU may be configured with a first CCA correlation threshold, for example, to determine a (e.g., preferred) CCA view configuration. A WTRU may be configured with a second CCA correlation threshold, for example, for error event detection.

In some examples, a WTRU may receive a CCA-enabled data channel. The WTRU may determine the combiners, for example, based on the configured CCA views. The WTRU may measure the CCA correlation coefficient for the received CCA views. The WTRU may compare the measured CCA correlation coefficient with a first CCA correlation threshold, if configured. The WTRU may determine an alternate CCA view configuration, for example, if the measured CCA correlation is smaller than the first configured CCA threshold. The WTRU may determine the alternate CCA view configuration, for example, if the channel conditions have changed. The WTRU may determine that an error event occurred, for example, if the measured CCA correlation is smaller than a second configured CCA threshold, and/or if the configured CCA view is the (e.g., preferred) view. In some examples, the WTRU may (e.g., alternatively) determine that an error event occurred if the measured CCA correlation threshold is smaller than the second configured CCA threshold for a pre-configured number of data transmission intervals (e.g., TTIs, slots).

In some examples, the WTRU may first measure the received SNR if the CCA correlation error detection threshold is a function of SNR. The WTRU may determine the error detection threshold. The WTRU may compare the measured CCA correlation coefficient to the determined error detection threshold, for example, to determine whether an error occurred.

A WTRU may be configured with one or more behaviors, for example, if (e.g., when) CCA error events are detected. The WTRU may indicate an error event to the gNB, for example, if the WTRU determines that a CCA error event occurred. The WTRU may send a request to fall back to a legacy DM-RS based data channel configuration (e.g., based on the CCA error event). The WTRU may report a HARQ NACK indication to the gNB, for example, based on (e.g., upon) detecting the CCA error event. The WTRU may (e.g., also) report the measured CCA correlation coefficient.

A WTRU may report an error event detection. In some examples, a WTRU may detect a CCA error event. The WTRU may report the CCA error event, for example, with the configured PUCCH transmission associated with the last downlink data assignment. In some examples, the WTRU may use a PUSCH (e.g., PUSCH transmission) to report a CCA error event and/or to request fallback to DM-RS transmissions. The WTRU may send a scheduling request for resources to report the error event, the measured CCA correlation coefficient, and/or the fallback request.

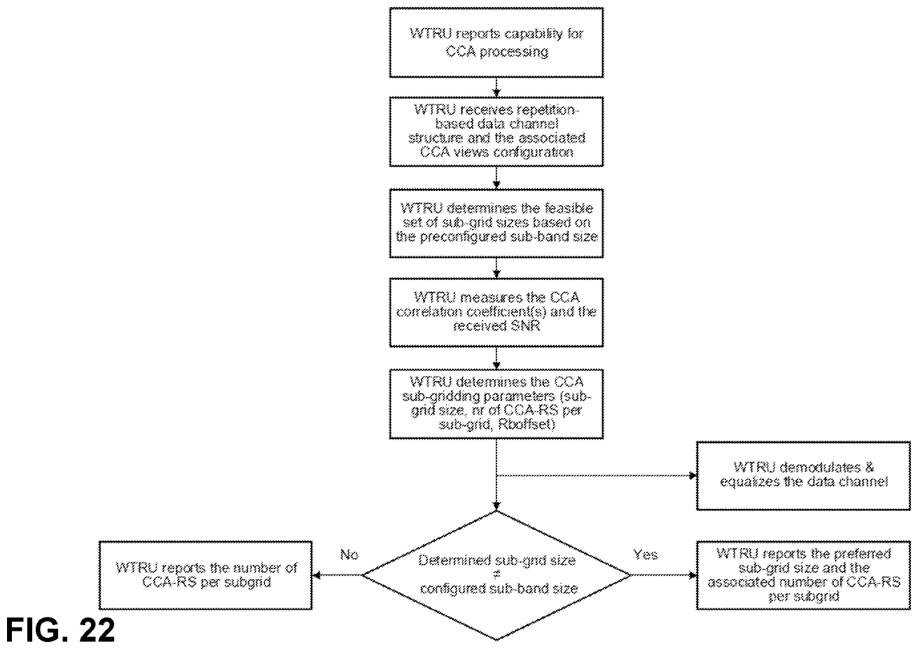

FIG. 22 illustrates an example of determining and reporting CCA sub-grid parameters. Features associated with determining preferred CCA sub-gridding parameter(s) are disclosed herein. A WTRU may be configured for CCA processing of the data channel, e.g., to determine the preferred CCA parameter(s). The WTRU may perform one or more of the following. The WTRU may report its CCA processing capability. The WTRU may be configured for CSI based feedback. The WTRU may receive CSI-RS(s). The WTRU may measure a channel and/or channel parameters, e.g., delay spread, Doppler, etc. The WTRU may receive configuration information (e.g., be configured) for CCA processing (e.g., repetition-based data channel structure information, which may, for example, include CCA view location(s), CCA subgridding parameters, performance thresholds, a configured sub-band size, etc., as shown in FIG. 22), e.g., for the data channel, which may include receiving or determining CCA view parameter(s) (e.g., a first CCA view associated with a data channel and a second CCA view associated with a data channel). CCA view parameters may include one or more of: location(s) of a repeated PDSCH RE, CCA view length (N), start symbol, RB offset, mapping order (e.g., time, frequency, or hybrid), default configuration of CCA-RS (e.g., pilots), etc. The WTRU may measure CCA correlation coefficient(s) (e.g., as shown in FIG. 22), e.g., based on (e.g., received) CCA view(s) and/or SNR (e.g., received SNR). The WTRU may determine sub-grid parameters/information (e.g., as shown in FIG. 22), such as, for example, one or more of: the CCA sub-grid size, e.g., based on one or more of: (e.g., received) CCA view(s), a measured CCA correlation coefficient, a configured CSI sub-band size, or PRG; a the number of CCA-RS (e.g., pilots) per sub-grid, e.g., based on one or more of: an SNR, an RSRP/RSRQ, or a CCA view length per sub-grid; and/or a number of sub-grids, e.g., based on one or more of: (e.g., received) CCA view(s) or a measured CCA correlation coefficient. The WTRU may demodulate and/or equalize the data channel with the received CCA view and the CCA-RS (e.g., as shown in FIG. 22). The WTRU may report a preferred CCA sub-grid size, a CCA correlation coefficient per sub-grid, and/or a preferred number of CCA-RS per sub-grid, for example if the determined CCA sub-grid size is different from the configured sub-band size/PRG size (e.g., where the WTRU may determine a (e.g., feasible) set of sub-grid sizes based on the configured sub-band size, for example, as shown in FIG. 22), as shown in FIG. 22. The WTRU may report the number of CCA-RS per sub-grid, e.g., if the determined CCA sub-grid size is not different from the configured sub-band size/PRG size (e.g., as shown in FIG. 22). The receiving and sending/reporting herein may be to a base station.

Features associated with WTRU fallback to legacy DM-RS are disclosed herein. A WTRU may be configured for CCA processing of a data channel, e.g., to fall back to legacy DM-RS processing. The WTRU may perform one or more of the following. The WTRU may be configured for CCA processing for the data channel. The WTRU may receive the CCA view configuration from the gNB. The WTRU may receive the CCA-enabled data channel. The WTRU may determine the combiners, e.g., based on the configured CCA views. The WTRU may measure the CCA correlation coefficient between the CCA views. The WTRU may compare the CCA correlation to a configured threshold. The WTRU may equalize the data channel using the determined combiners (e.g., legacy FEC processing may follow), for example, if measured CCA correlation is greater than the configured threshold. The WTRU may send a request to the gNB to switch to an alternate CCA view, for example, if the measured CCA correlation is less than the configured threshold and/or if the configured CCA view is not the preferred view. The WTRU may send a request to the gNB to fall back to (e.g., legacy) DM-RS data transmission, for example, if the measured CCA correlation is less than the configured threshold and/or if the configured CCA view is the preferred view.

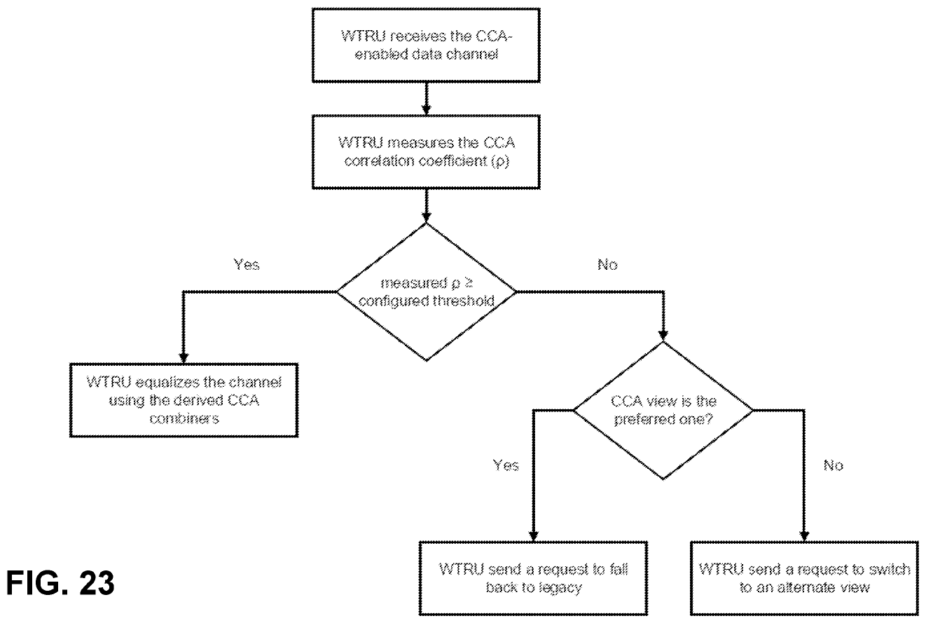

FIG. 23 illustrates an example associated with fall back to DM-RS data transmission, where a WTRU may perform one or more of the illustrated actions.

Features associated with a determination of (e.g., preferred) CCA repetition type and parameters are disclosed herein. A WTRU may be configured for CCA processing of the data channel, e.g., to determine a preferred CCA repetition type and/or parameters. The WTRU may perform one or more of the following. The WTRU may report the WTRU's CCA processing capability. The WTRU may be configured for CSI based feedback. The WTRU may receive a CSI-RS. The WTRU may measure a channel and/or channel parameters, e.g., delay spread, Doppler. The WTRU may be configured for CCA processing, e.g., for a data channel. CCA view parameters may include, for example, one or more of the following: a location of a repeated PDSCH RE, a CCA view length (N), a start symbol, an RB offset, a mapping order (e.g., time, frequency, or hybrid), and/or a default configuration of CCA-RS (e.g., pilots). The WTRU may measure (e.g., full) channel measurements CSI, e.g., based on the received CSI-RS. The WTRU may determine the CCA repetition type and/or CCA repetition boundary, e.g., based on channel measurement, a configured CSI sub-band size, and/or a PRG. The WTRU may report a preferred CCA repetition type and/or a CCA repetition boundary per sub-grid. The WTRU may demodulate and/or equalize the data channel with the received CCA view.

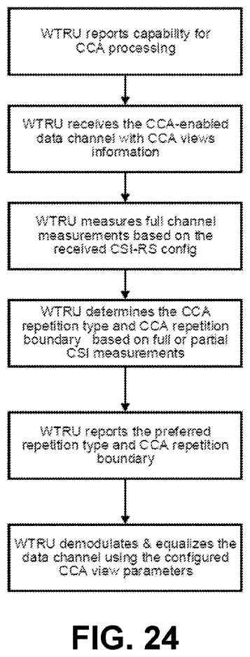

FIG. 24 illustrates an example associated with a determination of (e.g., preferred) CCA repetition type and parameters, where a WTRU may perform one or more of the illustrated actions.

Although features and elements described above are described in particular combinations, each feature or element may be used alone without the other features and elements of the preferred embodiments, or in various combinations with or without other features and elements.

Although the implementations described herein may consider 3GPP specific protocols, it is understood that the implementations described herein are not restricted to this scenario and may be applicable to other wireless systems. For example, although the solutions described herein consider LTE, LTE-A, New Radio (NR) or 5G specific protocols, it is understood that the solutions described herein are not restricted to this scenario and are applicable to other wireless systems as well.

The processes described above may be implemented in a computer program, software, and/or firmware incorporated in a computer-readable medium for execution by a computer and/or processor. Examples of computer-readable media include, but are not limited to, electronic signals (transmitted over wired and/or wireless connections) and/or computer-readable storage media. Examples of computer-readable storage media include, but are not limited to, a read only memory (ROM), a random access memory (RAM), a register, cache memory, semiconductor memory devices, magnetic media such as, but not limited to, internal hard disks and removable disks, magneto-optical media, and/or optical media such as compact disc (CD)-ROM disks, and/or digital versatile disks (DVDs). A processor in association with software may be used to implement a radio frequency transceiver for use in a WTRU, terminal, base station, RNC, and/or any host computer.

1-16. (canceled)

17. A wireless transmit/receive unit (WTRU) comprising:
a processor configured to:
receive canonical correlation analysis (CCA) configuration information;
determine, based on the CCA configuration information, a first CCA view and a second CCA view, wherein the first CCA view and the second CCA view are associated with a data channel;
measure a CCA correlation coefficient associated with the first CCA view and the second CCA view;
determine CCA sub-grid information based at least on the first CCA view, the second CCA view, and the CCA correlation coefficient, wherein the determined CCA sub-grid information comprises a determined sub-grid size, a determined number of sub-grids, and a determined number of CCA reference signals (CCA-RSs);
determine whether to send an indication of the determined sub-grid size based on whether the determined sub-grid size is equal to a configured sub-band size; and
send a report based on the determination of whether to send the indication of the determined sub-grid size, wherein the report indicates the determined number of CCA-RSs and the CCA correlation coefficient.

18. The WTRU of claim 17, wherein the processor is further configured to:
demodulate and equalize the data channel with a received CCA-RS, the first CCA view, and the second CCA view.

19. The WTRU of claim 17, wherein if the determined sub-grid size does not equal the configured sub-band size, the report indicates the determined grid size.

20. The WTRU of claim 17, wherein the processor is further configured to:
receive a channel state information reference signal (CSI-RS); and
perform a measurement associated with the CSI-RS, wherein the determined CCA sub-grid information is further based on the measurement associated with the CSI-RS.

21. The WTRU of claim 17, wherein the first CCA view comprises a first group of resource elements (REs), wherein the second CCS view comprises a second group of REs, and wherein the second group of REs comprises a copy of the first group of REs.

22. The WTRU of claim 17, wherein the first CCA view and the second CCA view are associated with a CCA view length, and wherein the CCS view length is associated with a repetition pattern density.

23. The WTRU of claim 17, wherein the determined sub-grid size is a number of resource blocks (RBs).

24. The WTRU of claim 17, wherein the CCA configuration information comprises a CCA view parameter, wherein the CCA view parameter is one or more of a location of a repeated resource element, a CCA view length, a start symbol, a resource block offset, a mapping order, or a CCA reference signal configuration.

25. A method comprising:
receiving canonical correlation analysis (CCA) configuration information;
determining, based on the CCA configuration information, a first CCA view and a second CCA view, wherein the first CCA view and the second CCA view are associated with a data channel;
measuring a CCA correlation coefficient associated with the first CCA view and the second CCA view;
determining CCA sub-grid information based at least on the first CCA view, the second CCA view, and the CCA correlation coefficient, wherein the determined CCA sub-grid information comprises a determined sub-grid size, a determined number of sub-grids, and a determined number of CCA reference signals (CCA-RSs);
determining whether to send an indication of the determined sub-grid size based on whether the determined sub-grid size is equal to a configured sub-band size; and
sending a report based on the determination of whether to send the indication of the determined sub-grid size, wherein the report indicates the determined number of CCA-RSs and the CCA correlation coefficient.

26. The method of claim 25, wherein the method further comprises:
demodulating and equalize the data channel with a received CCA-RS, the first CCA view, and the second CCA view.

27. The method of claim 25, wherein if the determined sub-grid size does not equal the configured sub-band size, the report indicates the determined grid size.

28. The method of claim 25, wherein the method further comprises:
receiving a channel state information reference signal (CSI-RS); and
performing a measurement associated with the CSI-RS, wherein the determined CCA sub-grid information is further based on the measurement associated with the CSI-RS.

29. The method of claim 25, wherein the first CCA view comprises a first group of resource elements (REs), wherein the second CCS view comprises a second group of REs, and wherein the second group of REs comprises a copy of the first group of RES.

30. The method of claim 25, wherein the first CCA view and the second CCA view are associated with a CCA view length, and wherein the CCS view length is associated with a repetition pattern density.

31. The method of claim 25, wherein the determined sub-grid size is a number of resource blocks (RBs).

32. The method of claim 25, wherein the CCA configuration information comprises a CCA view parameter, wherein the CCA view parameter is one or more of a location of a repeated resource element, a CCA view length, a start symbol, a resource block offset, a mapping order, or a CCA reference signal configuration.
